(19) United States
(12) Patent Application Publication
(10) Pub. No.: US 2020/0362441 A1
(43) Pub. Date: Nov. 19, 2020

(54) ALUMINUM ALLOY WIRE AND METHOD FOR PRODUCING ALUMINUM ALLOY WIRE

(71) Applicant: Sumitomo Electric Industries, Ltd., Osaka (JP)

(72) Inventors: Toru MAEDA, Osaka (JP); Tetsuya KUWABARA, Osaka (JP); Akiko INOUE, Osaka (JP); Hiroyuki OGIWARA, Osaka (JP)

(21) Appl. No.: 16/958,001

(22) PCT Filed: Dec. 21, 2018
(86) PCT No.: PCT/JP2018/047383

§ 371 Date: Jun. 25, 2020

(30) Foreign Application Priority Data
Jan. 5, 2018 (JP) 2018-000768

(51) Int. Cl. C22C 21/00; B22D 11/00; B22F 9/08; C22F 1/04; H01B 1/02

(52) U.S. Cl. CPC C22C 21/00; B22D 11/005; B22D 11/003; B22F 2301/052; C22F 1/04; H01B 1/023; B22F 9/082

(57) ABSTRACT

An aluminum alloy wire with a composition that contains at least one metallic element selected from the group consisting of Fe, Cr, Ni, Co, Ti, Sc, Zr, Nb, Hf, and Ta in the total amount of more than 1.4 atomic percent and 5.1 atomic percent or less and a remainder of Al and incidental impurities, wherein the aluminum alloy wire has a tensile strength of 250 MPa or more and an electrical conductivity of 50% IACS or more.

### TECHNICAL FIELD

The present disclosure relates to an aluminum alloy wire and a method for producing an aluminum alloy wire.

The present application claims the priority of Japanese Patent Application No. 2018-000768, filed Jan. 5, 2018, which is incorporated herein by reference in its entirety.

### BACKGROUND ART

Patent Literature 1 discloses a high-strength, high-toughness, electrically conductive aluminum alloy wire as a conductor wire for an electric wire, the aluminum alloy having a particular composition and being softened.

### CITATION LIST

### Patent Literature

PTL 1: Japanese Unexamined Patent Application Publication No. 2010-067591

### SUMMARY OF INVENTION

### Solution to Problem

An aluminum alloy wire according to the present disclosure has a composition that contains at least one metallic element selected from the group consisting of Fe, Cr, Ni, Co, Ti, Sc, Zr, Nb, Hf, and Ta in the total amount of more than 1.4 atomic percent and 5.1 atomic percent or less and a remainder of Al and incidental impurities, and has

a tensile strength of 250 MPa or more and

an electrical conductivity of 50% IACS or more.

Another aluminum alloy wire according to the present disclosure has a composition that contains more than 1.4 atomic percent and 5.1 atomic percent or less Fe, more than 0.006 atomic percent and 0.1 atomic percent or less Nd, and a remainder of Al and incidental impurities, and has

a tensile strength of 345 MPa or more,

an electrical conductivity of 50% IACS or more.

A method for producing an aluminum alloy wire according to the present disclosure includes the steps of:

producing a first material composed of an aluminum-based alloy with a composition that contains at least one metallic element selected from the group consisting of Fe, Cr, Ni, Co, Ti, Sc, Zr, Nb, Hf, and Ta in the total amount of more than 1.4 atomic percent and 5.1 atomic percent or less and a remainder of Al and incidental impurities, the metallic element being dissolved in the first material;

processing the first material at a temperature lower than or equal to the deposition temperature of the metallic element to produce a second material, and wiredrawing the second material to produce a wiredrawn product with a predetermined wire diameter; and

heat-treating the wiredrawn product to deposit a compound containing Al and the metallic element.

Another method for producing an aluminum alloy wire according to the present disclosure includes the steps of:

producing a first material composed of an aluminum-based alloy with a composition that contains more than 1.4 atomic percent and 5.1 atomic percent or less Fe, more than 0.006 atomic percent and 0.1 atomic percent or less Nd, and a remainder of Al and incidental impurities, the Fe and Nd being dissolved in the first material;

processing the first material at a temperature lower than or equal to the deposition temperature of Fe and Nd to produce a second material, and wiredrawing the second material to produce a wiredrawn product with a predetermined wire diameter; and

heat-treating the wiredrawn product to deposit a compound containing Al, Fe, and Nd.

### DESCRIPTION OF EMBODIMENTS

### Problems to be Solved by Present Disclosure

An electrically conductive higher-strength aluminum alloy wire is desired as a conductor wire for an electric wire.

An aluminum alloy wire described in Patent Literature 1 has high toughness with an elongation at break of 10% or more but has a tensile strength of 200 MPa or less. For example, extra-fine wires (for example, with a wire diameter of 100 μm or less) for use in earphones are desired to have an elongation at break of 10% or more and high fatigue strength in repeated bending so that sound vibration does not cut the extra-fine wires. The fatigue strength tends to increase with the tensile strength. In Patent Literature 1, however, the improvement in strength is limited due to an Fe content of 2.2% or less by mass. Thus, there is a demand for an aluminum alloy wire with higher tensile strength, particularly an aluminum alloy wire with a tensile strength of 250 MPa or more. A flexible aluminum alloy wire that has high elongation at break as well as high tensile strength is more preferred.

For conductor wire applications, high electrical conductivity is also desired. In general, the strength tends to increase with the additive element content of the alloy. For additive elements of a solid-solution strengthening type, however, the electrical conductivity decreases with increasing additive element content. This is due to an increase in the amount of additive element dissolved in the parent phase of the alloy. Even an additive element that can be deposited may decrease electrical conductivity in a certain state of deposition. For example, if the deposit is coarse particles, aggregates into a lump, or is a long continuous deposit, the deposit blocks an Al conductive path and increases electrical resistance. This results in low electrical conductivity. For example, a continuously casted rolled product or a billet cast product described in Patent Literature 1 made of an alloy containing a large amount of additive element that can be deposited tends to contain the coarse particles. The coarse particles are likely to become a starting point of breakage. Thus, wire drawing of the cast product results in poor wire drawability and consequently low productivity of the wiredrawn product. This also tends to result in the coarse particles remaining in the wiredrawn product or longer particles elongated by the wire drawing. Thus, the end product, a conductor wire, breaks easily from the starting point of coarse particles when pulled, bent, or repeatedly bent during use, and has low strength and fatigue strength.

Accordingly, it is an object of the present disclosure to provide a high-strength electrically conductive aluminum alloy wire. It is another object of the present disclosure to provide a method for producing an aluminum alloy wire by which a high-strength electrically conductive aluminum alloy wire can be produced.

### Advantageous Effects of Present Disclosure

An aluminum alloy wire according to the present disclosure has high strength and is electrically conductive. A method for producing an aluminum alloy wire according to the present disclosure can produce a high-strength electrically conductive aluminum alloy wire.

### DESCRIPTION OF EMBODIMENTS OF PRESENT DISCLOSURE

First, embodiments of the present disclosure are described below.

(1) An aluminum alloy wire according to an embodiment of the present disclosure has a composition that contains at least one metallic element selected from the group consisting of Fe, Cr, Ni, Co, Ti, Sc, Zr, Nb, Hf, and Ta in the total amount of more than 1.4 atomic percent and 5.1 atomic percent or less and a remainder of Al and incidental impurities, and has

a tensile strength of 250 MPa or more and

an electrical conductivity of 50% IACS or more.

As described in detail below, the above metallic element (hereinafter also referred to as a first element) forms a binary intermetallic compound with Al and is easily deposited. An aluminum-based alloy (hereinafter also referred to as an Al-based alloy) constituting an aluminum alloy wire (hereinafter also referred to as an Al alloy wire) according to the present disclosure contains the particular amount of the first element as an additive element.

The Al-based alloy contains a relatively large amount of the first element, such as Fe. The first element exists mainly as a deposit. Thus, an Al alloy wire according to the present disclosure has high strength with a high tensile strength of 250 MPa or more and is electrically conductive due to a high electrical conductivity of 50% IACS or more. Due to its high tensile strength, an Al alloy wire according to the present disclosure has high fatigue strength in repeated bending. Furthermore, an Al alloy wire according to the present disclosure does not have excessive rigidity in bending and can have lower spring back. Such an Al alloy wire according to the present disclosure is suitable for a conductor for use in an electric wire.

An Al alloy wire according to the present disclosure produced by a method for producing an Al alloy wire according to an embodiment of the present disclosure described later is less likely to break in wire drawing and has high productivity.

(2) In an Al alloy wire according to an embodiment of the present disclosure,

the metallic element is Fe.

This embodiment has high productivity as well as high strength and electrical conductivity. This is because when the first element is Fe a melt is easily produced in the production process. Furthermore, heat treatment after wire drawing facilitates the appropriate formation of a deposit and improves industrial productivity. In addition, because Fe is an easily-available element, the present embodiment can reduce production costs.

(3) In an Al alloy wire according to an embodiment of the present disclosure,

the metallic element is Cr, and the Cr content is 1.5 atomic percent or more and 3.3 atomic percent or less.

This embodiment has high strength and electrical conductivity. The present embodiment also has high productivity. This is because Cr is easily available in terms of industrial production.

(4) In an Al alloy wire according to an embodiment of the present disclosure,

the metallic element is Ni, and the Ni content is 1.6 atomic percent or more and 2.4 atomic percent or less.

This embodiment has high strength and electrical conductivity. The present embodiment also has high productivity. This is because Ni is easily available in terms of industrial production.

(5) In an Al alloy wire according to an embodiment of the present disclosure,

the metallic element is Co, and the Co content is 1.6 atomic percent or more and 1.9 atomic percent or less.

This embodiment has high strength and electrical conductivity. The present embodiment also has high productivity. This is because Co is easily available in terms of industrial production.

(6) In an Al alloy wire according to an embodiment of the present disclosure,

the metallic element is Ti, and the Ti content is 1.7 atomic percent or more and 4.1 atomic percent or less.

This embodiment has high strength and electrical conductivity. In particular, a compound containing Al and Ti tends to become finer. Thus, the present embodiment has higher strength. The present embodiment also has high productivity because Ti is easily available in terms of industrial production.

(7) In an Al alloy wire according to an embodiment of the present disclosure,

the metallic element is Sc, and the Sc content is 1.5 atomic percent or more and 3.1 atomic percent or less.

This embodiment has high strength and electrical conductivity. In particular, a compound containing Al and Sc can easily become finer. Thus, the present embodiment has higher strength.

(8) In an Al alloy wire according to an embodiment of the present disclosure,

the metallic element is Zr, and the Zr content is 1.5 atomic percent or more and 1.9 atomic percent or less.

This embodiment has high strength and electrical conductivity. In particular, a compound containing Al and Zr can easily become finer. Thus, the present embodiment has higher strength.

(9) In an Al alloy wire according to an embodiment of the present disclosure,

the metallic element is Nb, and the Nb content is 1.5 atomic percent or more and 3.2 atomic percent or less.

This embodiment has high strength and electrical conductivity. In particular, a compound containing Al and Nb can easily become finer. Thus, the present embodiment has higher strength.

(10) In an Al alloy wire according to an embodiment of the present disclosure,

the metallic element is Hf, and the Hf content is 1.6 atomic percent or more and 4.6 atomic percent or less.

This embodiment has high strength and electrical conductivity. In particular, a compound containing Al and Hf can easily become finer. Thus, the present embodiment has higher strength.

(11) In an Al alloy wire according to an embodiment of the present disclosure,

the metallic element is Ta, and the Ta content is 1.5 atomic percent or more and 3.6 atomic percent or less.

This embodiment has high strength and electrical conductivity. In particular, a compound containing Al and Ta can easily become finer. Thus, the present embodiment has higher strength.

(12) In an Al alloy wire according to an embodiment of the present disclosure,

the aluminum alloy wire has a structure that contains a parent phase and compound particles present in the parent phase, the parent phase being composed mainly of Al, and the compound particles being composed of a compound containing Al and the metallic element, and

the compound particles have a major-axis length of 500 nm or less, or an aspect ratio of 5 or less, or both in a longitudinal section cut in a plane in the axial direction.

Methods for measuring the major-axis length and the aspect ratio are described later in a test example 1.

The present embodiment appropriately has the strength improving effect due to dispersion strengthening of compound particles containing Al and the first element, has the effect of having high electrical conductivity due to a decreased amount of the first element dissolved in the parent phase, and has high strength and electrical conductivity. In particular, the compound particles in the present embodiment have a major-axis length as short as 500 nm or less in the longitudinal section. In another respect, the compound particles in the present embodiment have an aspect ratio as low as 5 or less in the longitudinal section. The compound particles are qualitatively close to spherical. The short compound particles or almost spherical compound particles are easily dispersed uniformly in the parent phase. Uniform dispersion of the compound particles in the present embodiment can further increase the strength. The present embodiment further reduces spring back, reduces blockage of an Al conductive path caused by the compound particles, and further improves electrical conductivity. Furthermore, in the present embodiment, the compound particles subjected to force in a direction across the axial direction of the Al alloy wire are less likely to become a starting point of breakage. Thus, the present embodiment is flexible and has higher fatigue strength. These effects are easily produced when the compound particles have a major-axis length of 500 nm or less and an aspect ratio of 5 or less. In the appropriate presence of the compound particles, therefore, the present embodiment tends to have high elongation at break and has high strength and toughness.

(13) In an Al alloy wire according to an embodiment of the present disclosure,

the aluminum alloy wire has a structure that contains a parent phase and compound particles present in the parent phase, the parent phase being composed mainly of Al, and the compound particles being composed of a compound containing Al and the metallic element,

a 5 μm×5 μm square measurement region is chosen in both a longitudinal section cut in a plane in the axial direction and a transverse section cut in a plane perpendicular to the axial direction,

the number of the compound particles in the measurement region in the longitudinal section is 950 or more and 1500 or less, and the ratio of the total area of the compound particles to the area of the measurement region in the longitudinal section is 5% or more and 20% or less, and

the number of the compound particles in the measurement region in the transverse section is 950 or more and 4500 or less, and the ratio of the total area of the compound particles to the area of the measurement region in the transverse section is 2.5% or more and 20% or less.

Methods for measuring the number and area ratio are described later in the test example 1.

The present embodiment appropriately has the strength improving effect due to dispersion strengthening of compound particles containing Al and the first element, has the effect of having high electrical conductivity due to a decreased amount of the first element dissolved in the parent phase, and has higher strength and electrical conductivity. In particular, the number of compound particles in the longitudinal section is similar to the number of compound particles in the transverse section, and the present embodiment has low directivity (anisotropy) in the existence of the compound particles. Thus, the present embodiment is flexible, has higher fatigue strength, and is less likely to cause work hardening in bending. In the present embodiment, the compound particles are fine. Thus, dispersion of the fine compound particles in the present embodiment can further increase the strength. Furthermore, the present embodiment further reduces spring back, reduces blockage of an Al conductive path caused by the compound particles, and further improves electrical conductivity. In the appropriate presence of the compound particles, therefore, the present embodiment tends to have high elongation at break and has high strength and toughness.

(14) In an Al alloy wire with a structure containing the compound particles according to one embodiment,

the metallic element content of the parent phase is less than 0.55 atomic percent in total.

This embodiment contains a very small amount of the first element dissolved in the parent phase, contains high-purity Al in the parent phase, and has higher electrical conductivity. Furthermore, in the present embodiment, the first element exists mainly as compound particles. Thus, the present embodiment appropriately has the strength improving effect due to dispersion strengthening of the compound particles and has higher strength.

(15) An aluminum alloy wire according to another embodiment of the present disclosure (hereinafter also referred to as a second Al alloy wire according to the present disclosure) has

a composition that contains more than 1.4 atomic percent and 5.1 atomic percent or less Fe, more than 0.006 atomic percent and 0.1 atomic percent or less Nd, and a remainder of Al and incidental impurities, and has

a tensile strength of 345 MPa or more and

an electrical conductivity of 50% IACS or more.

The present inventors have found that an Al-based alloy containing a minute amount of Nd in addition to the particular amount of Fe has significantly improved tensile strength and higher strength. The second Al alloy wire according to the present disclosure is based on this finding.

The second Al alloy wire according to the present disclosure is based on the Al-based alloy containing Fe as the first element and contains a minute amount of Nd as a second element. The Al-based alloy has a relatively high Fe content. Fe exists mainly as a deposit. Nd is contained in a deposit containing Fe (a compound containing Al and Fe). The deposit containing Nd (a compound containing Al, Fe, and Nd) is finer than the deposit without Nd. Due to the dispersion strengthening of the fine deposit, the second Al alloy wire according to the present disclosure has a very high tensile strength of 345 MPa or more and has high strength. The fine deposit is less likely to block an Al conductive path. Due to a very low Nd content, Nd is less likely to reduce electrical conductivity. The second Al alloy wire according to the present disclosure is electrically conductive due to a high electrical conductivity of 50% IACS or more. Furthermore, due to its high tensile strength, the second Al alloy wire according to the present disclosure has high fatigue strength in repeated bending. Furthermore, the second Al alloy wire according to the present disclosure does not have excessive rigidity in bending and can have lower spring back. The second Al alloy wire according to the present disclosure is suitable for a conductor for use in an electric wire.

The second Al alloy wire according to the present disclosure produced by a method for producing an Al alloy wire according to another embodiment of the present disclosure described later is less likely to break in wire drawing and has high productivity.

(16) In the second Al alloy wire according to an embodiment of the present disclosure,

the aluminum alloy wire has a structure that contains a parent phase and compound particles present in the parent phase, the parent phase being composed mainly of Al, and the compound particles being composed of a compound containing Al, Fe, and Nd, and

the compound particles have a major-axis length of 105 nm or less, or an aspect ratio of less than 3.3, or both in a longitudinal section cut in a plane in the axial direction.

The present embodiment appropriately has the strength improving effect due to dispersion strengthening of compound particles containing Al, Fe, and Nd, has the effect of having high electrical conductivity due to a decreased amount of Fe and Nd dissolved in the parent phase, and has high strength and electrical conductivity. In particular, the compound particles in the present embodiment have a major-axis length as short as 105 nm or less in the longitudinal section. In another respect, the compound particles in the present embodiment have an aspect ratio as low as less than 3.3 in the longitudinal section. The compound particles are qualitatively close to spherical. The compound particles are easily dispersed uniformly in the parent phase, as described above. Thus, the present embodiment is likely to have an effect resulting from the uniform dispersion of the compound particles. The effect may be improved strength, lower spring back, or improved electrical conductivity. The present embodiment is likely to have an effect resulting from a lower likelihood of the compound particles becoming a starting point of breakage. The effect may be high flexibility or improved fatigue strength. These effects are easily produced when the compound particles have a major-axis length of 105 nm or less and an aspect ratio of less than 3.3. In the appropriate presence of the compound particles, therefore, the present embodiment tends to have high elongation at break and has high strength and toughness.

(17) In the second Al alloy wire according to an embodiment of the present disclosure,

the aluminum alloy wire has a structure that contains a parent phase and compound particles present in the parent phase, the parent phase being composed mainly of Al, and the compound particles being composed of a compound containing Al, Fe, and Nd, and

a 5 μm×5 μm square measurement region is chosen in both a longitudinal section cut in a plane in the axial direction and a transverse section cut in a plane perpendicular to the axial direction, and the number of the compound particles in each measurement region is 2200 or more and 3800 or less, and the ratio of the total area of the compound particles to the area of each measurement region is 4.5% or more and 20% or less.

This embodiment appropriately has the strength improving effect due to dispersion strengthening of compound particles containing Al, Fe, and Nd, has the effect of having high electrical conductivity due to a decreased amount of Fe and Nd dissolved in the parent phase, and has higher strength and electrical conductivity. In particular, the number of compound particles in the longitudinal section is almost the same as the number of compound particles in the transverse section, and the present embodiment has low or substantially no directivity (anisotropy) in the existence of the compound particles. Thus, an effect resulting from the small anisotropy is easily produced. The effect may be high flexibility, improved fatigue strength, or a lower likelihood of work hardening by bending. The compound particles in the present embodiment are finer than the compound particles without Nd. Thus, the present embodiment is likely to have an effect resulting from the dispersion of the fine compound particles. The effect may be improved strength, lower spring back, or improved electrical conductivity. In the appropriate presence of the compound particles, therefore, the present embodiment tends to have high elongation at break and has high strength and toughness.

(18) In the second Al alloy wire according to an embodiment of the present disclosure,

the parent phase has an Fe content of less than 0.28 atomic percent.

This embodiment contains a very small amount of Fe dissolved in the parent phase, contains high-purity Al in the parent phase, and has higher electrical conductivity. Furthermore, in the present embodiment, Fe exists mainly as compound particles. Thus, the present embodiment appropriately has the strength improving effect due to dispersion strengthening of the compound particles and has higher strength.

(19) An Al alloy wire according to an embodiment of the present disclosure has a 0.2% proof stress of 50 MPa or more.

This embodiment has high breaking durability in an actual operating environment.

(20) An Al alloy wire according to an embodiment of the present disclosure has a 0.2% proof stress of 100 MPa or less, or an elongation at break of 10% or more, or both.

This embodiment has high tensile strength and electrical conductivity, as described above, has a moderate 0.2% proof stress of 100 MPa or less, and has a high elongation at break of 10% or more. The present embodiment is flexible, has higher fatigue strength, and is less likely to break upon impact. When an Al alloy wire with a 0.2% proof stress of 100 MPa or less is used as a conductor wire of an electric wire with a terminal and is attached to a crimp terminal, the Al alloy wire has high terminal coupling strength.

(21) A method for producing an aluminum alloy wire (Al alloy wire) according to an embodiment of the present disclosure (hereinafter also referred to as a first production method) includes the steps of:

producing a first material composed of an aluminum-based alloy with a composition that contains at least one metallic element selected from the group consisting of Fe, Cr, Ni, Co, Ti, Sc, Zr, Nb, Hf, and Ta in a total amount of more than 1.4 atomic percent and 5.1 atomic percent or less and a remainder of Al and incidental impurities, the metallic element being dissolved in the first material;

processing the first material at a temperature lower than or equal to the deposition temperature of the metallic element to produce a second material, and wiredrawing the second material to produce a wiredrawn product with a predetermined wire diameter; and

heat-treating the wiredrawn product to deposit a compound containing Al and the metallic element.

The present inventors have investigated the conditions under which an Al alloy wire can be productively produced from an Al-based alloy with a higher Fe content than Patent Literature 1 (2.2% by mass) with fewer wire breaks during wire drawing. It was found that wire drawing of an Al-based alloy containing dissolved Fe can be satisfactorily performed with fewer wire breaks by a method that enables more rapid cooling than known continuous casting methods using a movable mold or known casting methods using a fixed mold. It was also found that an electrically conductive high-strength Al alloy wire can be produced by performing heat treatment after wire drawing to deposit Fe. The heat treatment can eliminate processing strain caused by wire drawing, further improve electrical conductivity, improve elongation, and make bending easier. Furthermore, dissolved Fe prevents the deposit from being elongated by the wire drawing. This can also prevent low flexibility due to long deposit particles or blockage of an Al conductive path due to long deposit particles. Thus, the resulting Al alloy wire is flexible and has higher electrical conductivity. These findings with respect to Fe may apply to the first element (except Fe) that satisfies the particular conditions (I) and (II) described later. A method for producing an Al alloy wire according to the present disclosure is based on these findings.

A method for producing an Al alloy wire according to the present disclosure uses an Al-based alloy with a high first element content of more than 1.4 atomic percent (3% or more by mass when the first element is Fe). It should be noted that a material to be wire-drawn is substantially free of a deposit of the first element. This enables satisfactory wire drawing. The first element is deposited by heat treatment after wire drawing. Thus, a compound containing Al and the first element can be dispersed as fine particles. Thus, a method for producing an Al alloy wire according to the present disclosure can produce a high-strength Al alloy wire by the strength improving effect due to dispersion strengthening of fine compound particles.

The deposition of the first element can decrease the amount of the first element dissolved in the parent phase. The fine compound particles are less likely to block an Al conductive path. Thus, a method for producing an Al alloy wire according to the present disclosure can produce an electrically conductive Al alloy wire.

Such a method for producing an Al alloy wire according to the present disclosure can productively produce a high-strength electrically conductive Al alloy wire, typically, an Al alloy wire with a tensile strength of 250 MPa or more and an electrical conductivity of 50% IACS or more.

(22) A method for producing an aluminum alloy wire (Al alloy wire) according to another embodiment of the present disclosure (hereinafter also referred to as a second production method) includes the steps of:

producing a first material composed of an aluminum-based alloy with a composition that contains more than 1.4 atomic percent and 5.1 atomic percent or less Fe, more than 0.006 atomic percent and 0.1 atomic percent or less Nd, and a remainder of Al and incidental impurities, the Fe and Nd being dissolved in the first material;

processing the first material at a temperature lower than or equal to the deposition temperature of Fe and Nd to produce a second material, and wiredrawing the second material to produce a wiredrawn product with a predetermined wire diameter; and

heat-treating the wiredrawn product to deposit a compound containing Al, Fe, and Nd.

An Al-based alloy containing Nd with a high Fe content of more than 1.4 atomic percent is used in the second production method according to the present disclosure. It should be noted that a material to be wire-drawn is substantially free of Fe or Nd deposit. This enables satisfactory wire drawing. Fe and Nd are deposited by heat treatment after wire drawing. Thus, a compound containing Al, Fe, and Nd can be dispersed as fine particles. Thus, in the same manner as in the first production method, the second production method can produce a high-strength Al alloy wire by the strength improving effect due to dispersion strengthening of fine compound particles. In particular, Nd is likely to make the compound particles finer. Thus, the second production method can produce a higher-strength Al alloy wire.

The deposition of Fe and Nd can decrease the amount of Fe and Nd dissolved in the parent phase. Furthermore, the fine compound particles are less likely to block an Al conductive path, as described above. Thus, the second production method can produce an electrically conductive Al alloy wire in the same manner as in the first production method.

Such a second production method can productively produce a higher-strength electrically conductive Al alloy wire, typically, an Al alloy wire with a tensile strength of 345 MPa or more and an electrical conductivity of 50% IACS or more.

(23) In a method for producing an Al alloy wire according to an embodiment of the present disclosure,

the step of producing a first material includes quenching a melt of the aluminum-based alloy to produce the first material in thin band-like or powder form. The quenching means that the cooling rate of the melt is 10,000° C./s or more.

This embodiment produces the first material by using a liquid quenching solidification process or an atomization process. The present embodiment can appropriately produce a material in which the first element or Fe and Nd are dissolved.

(24) In a method for producing an Al alloy wire according to an embodiment of the present disclosure,

the heating temperature in the step of heat-treating the wiredrawn product is 300° C. or more.

In this embodiment, the first element or Fe and Nd can be easily deposited even in a relatively short time at a heating temperature of 300° C. or more in the heat-treatment step. The present embodiment can more productively produce a high-strength electrically conductive Al alloy wire due to the decreased heat-treatment time. Furthermore, the heat treatment at 300° C. or more provides an Al-based alloy with a stable crystal structure. Thus, the present embodiment can produce an Al alloy wire that is less likely to cause degradation in strength or electrical conductivity over time even in a high-temperature operating environment and that has high strength and electrical conductivity for extended periods.

### DETAILS OF EMBODIMENTS OF PRESENT DISCLOSURE

Embodiments of the present disclosure are described in detail below.

### [Aluminum Alloy Wire]

### (Outline)

An aluminum alloy wire (Al alloy wire) according to an embodiment is composed of an aluminum-based alloy (Al-based alloy). An Al alloy wire according to an embodiment is typically used in the form of a solid wire, a stranded wire, or a compressed stranded wire as a conductor for an electric wire. The stranded wire is made of twisted Al alloy wires. The compressed stranded wire is formed by compressing the stranded wire in a predetermined shape.

An Al alloy wire according to an embodiment has a particular composition containing a particular amount of particular metallic element, more specifically, the following first element or the first element and a second element (Nd). An Al alloy wire according to an embodiment has high strength and electrical conductivity because the particular metallic element exists mainly as a deposit. More specifically, a first Al alloy wire according to an embodiment has a composition containing the following first element in the total amount of more than 1.4 atomic percent and 5.1 atomic percent or less and a remainder of Al and incidental impurities and has a tensile strength of 250 MPa or more and an electrical conductivity of 50% IACS or more. The first element is at least one metallic element selected from the group consisting of Fe (iron), Cr (chromium), Ni (nickel), Co (cobalt), Ti (titanium), Sc (scandium), Zr (zirconium), Nb (niobium), Hf (hafnium), and Ta (tantalum). The second Al alloy wire according to an embodiment has a composition containing more than 1.4 atomic percent and 5.1 atomic percent or less Fe, more than 0.006 atomic percent and 0.1 atomic percent or less Nd (neodymium), and a remainder of Al and incidental impurities, and has a tensile strength of 345 MPa or more and an electrical conductivity of 50% IACS or more.

The details are described below.

### (Composition)

An Al-based alloy constituting the first Al alloy wire according to an embodiment may contain one of the first elements as an additive element and may be a binary alloy of Al and the first element. An Al-based alloy constituting the second Al alloy wire according to an embodiment contains one of the first elements Fe, is based on a binary alloy of Al and Fe, and contains Nd as a second element. Each first element satisfies the following conditions (I) and (II).

(I) The amount of the first element dissolved in Al at 660° C. and at 1 atmospheric pressure (equilibrium state) is 0.5% or less by mass.

(II) The first element forms an intermetallic compound with Al, and a binary metallic compound with the lowest first element ratio among binary intermetallic compounds of Al and the first element has a melting or decomposition temperature of 800° C. or more.

For example, the first element can be dissolved in the parent phase by quenching a melt of an Al-based alloy containing the particular amount of the first element satisfying the conditions (I) and (II) in the production process, as described later. For example, an Al-based alloy in which the first element is dissolved can be heat-treated before and/or after wire drawing to deposit the first element from the parent phase as a compound containing Al and the first element. This compound has a higher melting or decomposition temperature than the parent phase and is stable. Thus, the compound is easily produced.

A higher first element content of the Al-based alloy tends to result in an increased amount of the compound and improved strength. Quantitatively, the tensile strength can be 250 MPa or more. Even at a high first element content, high electrical conductivity can be achieved when the first element exists mainly as the compound (when the compound is present in a large amount). This is because the amount of the first element dissolved in the parent phase can be decreased to improve the purity of Al in the parent phase. When the compound is fine or close to spherical, the compound is less likely to block the Al conductive path, thus resulting in higher electrical conductivity.

On the other hand, a slightly low first element content of the Al-based alloy results in less blockage of the Al conductive path due to the presence of the compound and tends to result in high electrical conductivity. Quantitatively, the electrical conductivity can be 50% IACS or more. In the production of an Al alloy wire according to an embodiment by a method for producing an Al alloy wire according to an embodiment described later, it is easy to produce an Al alloy wire in which the first element contained in the Al-based alloy is substantially entirely dissolved and the compound is not substantially deposited. In this respect, wire drawing can be easily performed with high productivity.

Thus, the first element content is more than 1.4 atomic percent and 5.1 atomic percent or less of the Al-based alloy in total. For a binary alloy containing one of the first elements as an additive element of the Al-based alloy, the first element content may satisfy the following ranges. When two or more of the first elements are contained as additive elements of the Al-based alloy, the first element content may satisfy the following ranges and is more than 1.4 atomic percent and 5.1 atomic percent or less in total. Each element is described below.

### <Fe>

For the first element Fe, the Fe content may be more than 1.4 atomic percent and 5.1 atomic percent or less. At an Fe content in the above range, Fe exists mainly as a compound with Al, and the Al alloy wire can have high strength and electrical conductivity. At an Fe content of 1.45 atomic percent or more, 1.7 atomic percent or more, 1.9 atomic percent or more, or 2.0 atomic percent or more, the Al alloy wire can have higher strength. At an Fe content of 5.0 atomic percent or less, 4.8 atomic percent or less, or 4.6 atomic percent or less, the Al alloy wire can have higher electrical conductivity. For example, the Al alloy wire can have a high electrical conductivity of 55% IACS or more.

An embodiment in which the first element is Fe is preferred because the embodiment is suitable for industrial mass production and has high productivity for the following reasons.

(1) For Fe, a melt containing Al and Fe is easy to produce in the production process.

(2) A compound containing Fe and Al (for example, Al₁₃Fe₄, etc.) has a high melting point of 1100° C. or more and is stable. Thus, the compound can be satisfactorily deposited by heat treatment after wire drawing.

(3) Fe is an easily-available element and can decrease production costs.

A binary Al-based alloy containing more than 1.4 atomic percent and 5.1 atomic percent or less Fe corresponds approximately to a binary Al-based alloy containing 3% or more by mass and 10% or less by mass Fe on a mass basis. The Fe content of 3% or more by mass is higher than 2.2% by mass described in Patent Literature 1. Due to the high Fe content, the embodiment in which the first element is Fe has high strength. At an Fe content of 3.5% or more by mass, 3.8% or more by mass, or 4.0% or more by mass, the Al alloy wire can have higher strength. At an Fe content of 9.8% or less by mass, 9.5% or less by mass, or 9.0% or less by mass, the Al alloy wire can have higher electrical conductivity. The above conversion is based on the atomic weight of Al of 26.98 and the atomic weight of Fe of 55.85.

### <Nd>

The first element Fe may be combined with Nd. The Nd content may be more than 0.006 atomic percent and 0.1 atomic percent or less of the Al-based alloy. The Nd content may be more than 0.006 atomic percent and 0.1 atomic percent or less of the total amount of Al and Nd. At a Nd content in the above range, Nd is mainly contained in a compound of Al and Fe. Thus, Nd is less likely to increase electrical conductivity. A compound containing Al, Fe, and Nd tends to become finer than a compound containing Al and Fe. Thus, an embodiment containing Fe and Nd in the above range can be an electrically conductive higher-strength Al alloy wire. For example, the Al alloy wire can have a high tensile strength of 350 MPa or more or 360 MPa or more. Because Nd has a lower melting point than Fe, a melt containing Al, Fe, and Nd can be easily produced in the production process. In this respect, the embodiment containing Fe and Nd in the above range also has high productivity.

At a Nd content of 0.008 atomic percent or more or 0.010 atomic percent or more, the Al alloy wire can have higher strength. At a Nd content of 0.099 atomic percent or less, the Al alloy wire can have higher electrical conductivity.

### <Cr>

For the first element Cr, the Cr content may be 1.5 atomic percent or more and 3.3 atomic percent or less. At a Cr content in the above range, Cr exists mainly as a compound with Al, and the Al alloy wire can have good performance, for example, with a tensile strength of 253 MPa or more and an electrical conductivity of 55% IACS or more. At a higher Cr content within the above range, the Al alloy wire can have a high tensile strength of 300 MPa or more or 310 MPa or more, for example. At a lower Cr content within the above range, the Al alloy wire can have a high electrical conductivity of 57% IACS or more, for example. Cr is easily available in terms of industrial production. In this respect, an embodiment in which the first element is Cr also has high productivity.

### <Ni>

For the first element Ni, the Ni content may be 1.6 atomic percent or more and 2.4 atomic percent or less. At a Ni content in the above range, Ni exists mainly as a compound with Al, and the Al alloy wire can have good performance, for example, with a tensile strength of 290 MPa or more and an electrical conductivity of 55% IACS or more. At a higher Ni content within the above range, the Al alloy wire can have a high tensile strength of 300 MPa or more or 320 MPa or more, for example. At a lower Ni content within the above range, the Al alloy wire can have a high electrical conductivity of 56% IACS or more, for example. Ni is easily available in terms of industrial production. In this respect, an embodiment in which the first element is Ni also has high productivity.

### <Co>

For the first element Co, the Co content may be 1.6 atomic percent or more and 1.9 atomic percent or less. At a Co content in the above range, Co exists mainly as a compound with Al, and the Al alloy wire can have good performance, for example, with a tensile strength of 250 MPa or more and an electrical conductivity of 52% IACS or more. At a higher Co content within the above range, the Al alloy wire can have a high tensile strength of 300 MPa or more or 310 MPa or more, for example. At a lower Co content within the above range, the Al alloy wire can have a high electrical conductivity of 56% IACS or more or even 58% IACS or more, for example. Co is easily available in terms of industrial production. In this respect, an embodiment in which the first element is Ni also has high productivity.

### <Ti>

For the first element Ti, the Ti content may be 1.7 atomic percent or more and 4.1 atomic percent or less. At a Ti content in the above range, Ti exists mainly as a compound with Al, and the Al alloy wire can have good performance, for example, with a tensile strength of 270 MPa or more and an electrical conductivity of 50% IACS or more. At a higher Ti content within the above range, the Al alloy wire can have a high tensile strength of 300 MPa or more, 340 MPa or more, or 360 MPa or more, for example. At a lower Ti content within the above range, the Al alloy wire can have a high electrical conductivity of 55% IACS or more, for example. An intermetallic compound of Al and Ti has a higher melting point of 1300° C. or more and is more stable. Thus, the intermetallic compound is easily deposited, and the deposit tends to become finer. In this respect, an embodiment in which the first element is Ti tends to further increase the strength. Ti is easily available in terms of industrial production. In this respect, an embodiment in which the first element is Ti also has high productivity.

### <Sc>

For the first element Sc, the Sc content may be 1.5 atomic percent or more and 3.1 atomic percent or less. At a Sc content in the above range, Sc exists mainly as a compound with Al, and the Al alloy wire can have good performance, for example, with a tensile strength of 300 MPa or more or 310 MPa or more and an electrical conductivity of 53% IACS or more. At a higher Sc content within the above range, the Al alloy wire can have a high tensile strength of 360 MPa, more or 380 MPa or more, or 390 MPa or more, for example. At a lower Sc content within the above range, the Al alloy wire can have a high electrical conductivity of 55% IACS or more or 57% IACS or more, for example. An intermetallic compound of Al and Sc has a higher melting point of 1300° C. or more and is more stable. Thus, the intermetallic compound is easily deposited, and the deposit tends to become finer. In this respect, an embodiment in which the first element is Sc tends to further increase the strength.

### <Zr>

For the first element Zr, the Zr content may be 1.5 atomic percent or more and 1.9 atomic percent or less. At a Zr content in the above range, Zr exists mainly as a compound with Al, and the Al alloy wire can have good performance, for example, with a tensile strength of 270 MPa or more and an electrical conductivity of 50% IACS or more. At a higher Zr content within the above range, the Al alloy wire can have a high tensile strength of 300 MPa or more, 340 MPa or more, or 360 MPa or more, for example. At a lower Zr content within the above range, the Al alloy wire can have a high electrical conductivity of 52% IACS or more, for example. An intermetallic compound of Al and Zr has a higher melting point of 1300° C. or more and is more stable. Thus, the intermetallic compound is easily deposited, and the deposit tends to become finer. In this respect, an embodiment in which the first element is Zr tends to further increase the strength.

### <Nb>

For the first element Nb, the Nb content may be 1.5 atomic percent or more and 3.2 atomic percent or less. At a Nb content in the above range, Nb exists mainly as a compound with Al, and the Al alloy wire can have good performance, for example, with a tensile strength of 260 MPa or more and an electrical conductivity of 50% IACS or more. At a higher Nb content within the above range, the Al alloy wire can have a high tensile strength of 300 MPa or more or 320 MPa or more, for example. At a lower Nb content within the above range, the Al alloy wire can have a high electrical conductivity of 53% IACS or more, for example. An intermetallic compound of Al and Nb has a higher melting point of 1300° C. or more and is more stable. Thus, the intermetallic compound is easily deposited, and the deposit tends to become finer. In this respect, an embodiment in which the first element is Nb tends to further increase the strength.

### <Hf>

For the first element Hf, the Hf content may be 1.6 atomic percent or more and 4.6 atomic percent or less. At a Hf content in the above range, Hf exists mainly as a compound with Al, and the Al alloy wire can have good performance, for example, with a tensile strength of 280 MPa or more and an electrical conductivity of 52% IACS or more. At a higher Hf content within the above range, the Al alloy wire can have a high tensile strength of 300 MPa or more, 340 MPa or more, or 360 MPa or more, for example. At a lower Hf content within the above range, the Al alloy wire can have a high electrical conductivity of 54% IACS or more or 56% IACS or more, for example. An intermetallic compound of Al and Hf has a higher melting point of 1300° C. or more and is more stable. Thus, the intermetallic compound is easily deposited, and the deposit tends to become finer. In this respect, an embodiment in which the first element is Hf tends to further increase the strength.

### <Ta>

For the first element Ta, the Ta content may be 1.5 atomic percent or more and 3.6 atomic percent or less. At a Ta content in the above range, Ta exists mainly as a compound with Al, and the Al alloy wire can have good performance, for example, with a tensile strength of 260 MPa or more and an electrical conductivity of 50% IACS or more. At a higher Ta content within the above range, the Al alloy wire can have a high tensile strength of 300 MPa or more or 320 MPa or more, for example. At a lower Ta content within the above range, the Al alloy wire can have a high electrical conductivity of 53% IACS or more, for example. An intermetallic compound of Al and Ta has a higher melting point of 1300° C. or more and is more stable. Thus, the intermetallic compound is easily deposited, and the deposit tends to become finer. In this respect, an embodiment in which the first element is Ta tends to further increase the strength.

### <Others>

The term “the first element content” or “the Nd content”, as used herein, refers to the amount in the Al-based alloy constituting the Al alloy wire. In the production process, when a raw material (typically, aluminum metal) contains the first element as an impurity, the amount of the first element to be added to the raw material may be adjusted so that the desired first element content is achieved in the range of more than 1.4 atomic percent and 5.1 atomic percent or less in total. The same holds for a raw material containing Nd as an impurity.

### (Structure)

The first Al alloy wire according to an embodiment typically has a structure that contains a parent phase and compound particles present in the parent phase, the parent phase being composed mainly of Al, and the compound particles being composed of a compound containing Al and the first element. The second Al alloy wire containing Fe and Nd according to an embodiment typically has a structure that contains a parent phase and compound particles present in the parent phase, the parent phase being composed mainly of Al, and the compound particles being composed of a compound containing Al, Fe, and Nd. The compound particles dispersed in the parent phase enable an Al alloy wire according to an embodiment to have the strength improving effect due to dispersion strengthening and the effect of having high electrical conductivity due to a decreased amount of the first element and Nd dissolved in the parent phase. Thus, the Al alloy wire can keep the balance of high tensile strength and high electrical conductivity.

The parent phase of the Al-based alloy is composed of Al, elements dissolved in Al (the first element, Nd), and incidental impurities. The parent phase typically contains 99.4 atomic percent or more Al. The parent phase is the phase excluding the compound in the Al-based alloy.

### <Size of Compound Particle>

The strength improving effect due to dispersion strengthening can be more easily produced with finer compound particles, particularly finer particles of 1 μm or less. For example, in an embodiment (a-1), the compound particles in the first Al alloy wire according to an embodiment have a major-axis length of 500 nm or less in a longitudinal section of the Al alloy wire cut in a plane in the axial direction of the Al alloy wire.

The compound particles with a major-axis length of 500 nm or less do not extend in the axial direction of the Al alloy wire and are short particles. The short compound particles tend to be isolated from one another and dispersed in the parent phase. Thus, the embodiment (a-1) has a structure in which the short compound particles are dispersed. The short compound particles tend to be more uniformly dispersed in the parent phase than long particles. The Al alloy wire according to the embodiment (a-1) has at least one of the following effects.

(i) The Al alloy wire has higher strength due to dispersion strengthening of fine compound particles.

(ii) The Al alloy wire does not have excessive rigidity in bending and can have lower spring back.

(iii) The Al alloy wire has higher electrical conductivity because the short compound particles are less likely to block the Al conductive path in the axial direction of the Al alloy wire.

(iv) Due to their short size, the compound particles subjected to force in a direction across the axial direction of the Al alloy wire are less likely to become a starting point of breakage. Thus, the Al alloy wire is flexible, is less likely to break by repeated bending, and has higher fatigue strength.

These effects are more easily produced when the major-axis length decreases. The major-axis length is preferably 450 nm or less, 400 nm or less, or 380 nm or less.

In addition to the embodiment (a-1), more preferred is an embodiment (a-2) in which the compound particles have a major-axis length of 500 nm or less in a transverse section of the Al alloy wire cut in a plane perpendicular to the axial direction. The compound particles with a major-axis length of 500 nm or less in the transverse section do not extend in a direction perpendicular to the axial direction of the Al alloy wire (typically in the radial direction of the wire) and are short particles. The embodiment (a-2) has a structure in which the short compound particles are dispersed in any direction and has low or substantially no directivity (anisotropy) in the size of the compound particles. Such an Al alloy wire has at least one effect of improved strength, lower spring back, improved flexibility, improved breaking strength, and improved impact resistance. The Al alloy wire has higher electrical conductivity because the Al conductive path can be easily secured in any direction. These effects are more easily produced when the major-axis length in the transverse section decreases. Thus, the major-axis length is preferably 450 nm or less, 400 nm or less, or 350 nm or less. In particular, when the major-axis length in the transverse section is 300 nm or less, 280 nm or less, 250 nm or less, or 150 nm or less, it is easier to produce the strength improving effect due to dispersion strengthening of fine compound particles and the electrical conductivity improving effect due to the secured Al conductive path.

One example of the second Al alloy wire containing Fe and Nd according to an embodiment is an embodiment (a-3) in which the compound particles containing Nd have a major-axis length of 105 nm or less in the longitudinal section of the Al alloy wire. The compound particles have a shorter major-axis length in the embodiment (a-3) than in the embodiment (a-1). Such compound particles tend to be more uniformly dispersed in the parent phase. Thus, the embodiment (a-3) can satisfactorily have the effects (i) to (iv). The embodiment (a-3) with a major-axis length of 100 nm or less or 98 nm or less can more satisfactorily have the effects (i) to (iv) and is preferred.

For the reason described in the embodiment (a-2), the embodiment (a-3) is also more preferably an embodiment (a-4) in which the compound particles containing Nd have a major-axis length of 105 nm or less in the transverse section of the Al alloy wire. The embodiment (a-4) also has at least one effect of improved strength, lower spring back, improved flexibility, improved breaking strength, and improved impact resistance and has much higher electrical conductivity when the major-axis length in the transverse section decreases. Thus, the major-axis length in the transverse section is preferably 100 nm or less, 90 nm or less, or 80 nm or less.

The major-axis length of the compound particles in the longitudinal section may be longer than the major-axis length of the compound particles in the transverse section. In this case, the strength improving effect due to dispersion strengthening of fine compound particles and the electrical conductivity improving effect due to the secured Al conductive path can be satisfactorily produced when the major-axis length in the longitudinal section is more than once and not more than 5 times, not more than 4 times, not more than 3 times, or not more than 1.5 times the major-axis length in the transverse section.

It is not clear why the major-axis length of the compound particles in the longitudinal section is longer than the major-axis length of the compound particles in the transverse section. This is probably because acicular alloying regions serving as cores of the compound particles are formed at an atomic level (on the order of nanometers) before wire drawing, and the acicular regions undergo plastic deformation and are aligned in the wire drawing direction during wire drawing. This assumption is also applied to the aspect ratio described later.

### <Shape of Compound Particle>

The compound particles are preferably close to spherical so as not to become a starting point of breakage or block the Al conductive path. One example is an embodiment (b-1) in which the compound particles in the first Al alloy wire according to an embodiment have an aspect ratio of 5 or less in the longitudinal section.

The compound particles with an aspect ratio of 5 or less are elliptical with the major-axis length being not more than 5 times as long as the minor-axis length and are close to spherical. Thus, the embodiment (b-1) has a structure in which the spherical compound particles are dispersed in the parent phase. The spherical compound particles tend to be more uniformly dispersed than elongated particles. Thus, the Al alloy wire according to the embodiment (b-1) has at least one of the following effects.

(v) The Al alloy wire has higher strength due to dispersion strengthening of the spherical compound particles.

(vi) The Al alloy wire does not have excessive rigidity in bending and can have lower spring back.

(vii) The Al alloy wire has higher electrical conductivity because the spherical compound particles are less likely to block the Al conductive path in the axial direction of the Al alloy wire than elongated particles.

(viii) Due to their spherical shape, the compound particles subjected to force in a direction across the axial direction of the Al alloy wire are less likely to become a starting point of breakage. Thus, the Al alloy wire is flexible, is less likely to break by repeated bending, and has higher fatigue strength.

These effects are more easily produced as the aspect ratio approaches 1, and the aspect ratio is preferably 4.5 or less, 4.0 or less, or 3.5 or less.

In addition to the embodiment (b-1), more preferred is an embodiment (b-2) in which the compound particles in the transverse section of the Al alloy wire have an aspect ratio of 5 or less. The compound particles with an aspect ratio of 5 or less in the transverse section are close to spherical, as described above. The embodiment (b-2) has a structure in which the spherical compound particles are dispersed in any direction and has low or substantially no directivity (anisotropy) in the shape of the compound particles. Such an Al alloy wire has at least one effect of improved strength, lower spring back, improved flexibility, improved breaking strength, and improved impact resistance. The Al alloy wire has higher electrical conductivity because the Al conductive path can be easily secured in any direction. These effects are more easily produced as the aspect ratio in the transverse section approaches 1. Thus, the aspect ratio is preferably 4.5 or less, 4.0 or less, or 3.5 or less. In particular, when the aspect ratio in the transverse section is 3.0 or less, 2.9 or less, or 2.8 or less, it is easier to produce the strength improving effect due to dispersion strengthening of the spherical compound particles and the electrical conductivity improving effect due to the secured Al conductive path.

In the embodiments (b-1) and (b-2), the aspect ratio may be more than 1 or 1.5 or more. The same holds for embodiments (b-3) and (b-4) described later.

The first Al alloy wire according to an embodiment preferably satisfies at least one, more preferably both, of the embodiments (a-1) and (b-1). The first Al alloy wire still more preferably satisfies at least one of the embodiments (a-2) and (b-2). In particular, the first Al alloy wire still more preferably satisfies both of the embodiments (a-2) and (b-2). This is because the compound particles in any cross section are fine and close to spherical and therefore tend to be more uniformly dispersed. Such an Al alloy wire is preferred because the Al alloy wire can more easily have the strength improving effect due to dispersion strengthening of compound particles and the electrical conductivity improving effect due to the secured Al conductive path and has good mechanical characteristics as described above.

One example of the second Al alloy wire containing Fe and Nd according to an embodiment is the embodiment (b-3) in which the compound particles containing Nd have an aspect ratio of less than 3.3 in the longitudinal section of the Al alloy wire. The compound particles have a lower aspect ratio in the embodiment (b-3) than in the embodiment (b-1) and are closer to spherical. Such compound particles tend to be more uniformly dispersed in the parent phase. Thus, the embodiment (b-3) can satisfactorily have the effects (v) to (viii). The embodiment (b-3) with an aspect ratio of 3.2 or less or 3.1 or less can more satisfactorily have the effects (v) to (viii) and is preferred.

For the reason described in the embodiment (b-2), the embodiment (b-3) is also more preferably an embodiment (b-4) in which the compound particles containing Nd have an aspect ratio of less than 3.3 in the transverse section of the Al alloy wire. The embodiment (b-4) also has at least one effect of improved strength, lower spring back, improved flexibility, improved breaking strength, and improved impact resistance when the aspect ratio in the transverse section decreases. In particular, the aspect ratio in the transverse section is preferably 2.5 or less or 2.3 or less.

The second Al alloy wire according to an embodiment preferably satisfies at least one, more preferably both, of the embodiments (a-3) and (b-3). The second Al alloy wire still more preferably satisfies at least one of the embodiments (a-4) and (b-4). In particular, the second Al alloy wire still more preferably satisfies both of the embodiments (a-4) and (b-4). This is because the compound particles containing Nd in any cross section are fine and closer to spherical and therefore tend to be more uniformly dispersed. Such an Al alloy wire is preferred because the Al alloy wire can more satisfactorily have the strength improving effect due to dispersion strengthening of compound particles and the electrical conductivity improving effect due to the secured Al conductive path and has better mechanical characteristics as described above.

The compound particles in the longitudinal section may have a higher aspect ratio than the compound particles in the transverse section. In this case, the strength improving effect due to dispersion strengthening of spherical compound particles and the electrical conductivity improving effect due to the secured Al conductive path can be satisfactorily produced when the aspect ratio in the longitudinal section is at least once and not more than twice, not more than 1.9 times, not more than 1.8 times, or not more than 1.5 times the aspect ratio in the transverse section.

### <Number of Compound Particles>

The number of compound particles composed of the compound containing Al and the first element in the longitudinal section of the Al alloy wire is preferably close to that in the transverse section of the Al alloy wire. This is because the strength improving effect due to dispersion strengthening of the compound particles and the electrical conductivity improving effect due to the secured Al conductive path can be more appropriately produced and is also due to good mechanical characteristics. For example, in the first Al alloy wire according to an embodiment, the following measurement regions in the longitudinal section and the transverse section may satisfy the following embodiment (c). The measurement region in the longitudinal section and the measurement region in the transverse section are 5 μm×5 μm square regions.

### Embodiment c

In the measurement region in the longitudinal section, the number of compound particles composed of the compound containing Al and the first element is 950 or more and 1500 or less. The ratio of the total area of the compound particles to the area of the measurement region in the longitudinal section is 5% or more and 20% or less.

The number of the compound particles in the measurement region in the transverse section is 950 or more and 4500 or less. The ratio of the total area of the compound particles to the area of the measurement region in the transverse section is 2.5% or more and 20% or less.

The number of the compound particles is similar in any direction, and the embodiment (c) has low directivity (anisotropy) in the existence of the compound particles. Both the number and the area ratio in the embodiment (c) satisfy the above ranges, and each compound particle has a small area and is fine. Such an Al alloy wire has higher strength. The Al alloy wire according to the embodiment (c) has at least one effect of lower spring back, improved flexibility, improved fatigue strength, resistance to work hardening in bending, fewer wire breaks due to work hardening, and less breakage due to impact. Furthermore, the fine compound particles are less likely to block the Al conductive path and result in higher electrical conductivity.

When the number is 950 or more and the area ratio is 5% or more in the longitudinal section in the embodiment (c), this results in the appropriate presence of the compound particles and good mechanical characteristics, as described above. This effect is more easily produced when the number is increased and the area ratio is increased. For example, the number being 960 or more or 970 or more results in higher strength. The number being 1000 or more, 1050 or more, 1200 or more, or 1400 or more results in much higher strength. Alternatively, for example, an area ratio of 6% or more, 8% or more, or 10% or more results in higher strength. In particular, an area ratio of 14% or more, 15% or more, or 18% or more results in much higher strength.

When the number is 1500 or less and the area ratio is 20% or less in the longitudinal section in the embodiment (c), the compound particles are less likely to block the Al conductive path, which results in high electrical conductivity. This effect is more easily produced when the number is decreased and the area ratio is decreased. For example, the number being 1450 or less, 1400 or less, or 1250 or less results in higher electrical conductivity. Alternatively, for example, an area ratio of 19% or less, 18% or less, or 17% or less results in higher electrical conductivity.

When the number is 950 or more and the area ratio is 2.5% or more in the transverse section in the embodiment (c), this results in the appropriate presence of the compound particles and good mechanical characteristics, as described above. This effect is more easily produced when the number is increased and the area ratio is increased. For example, the number being 1000 or more results in higher strength. The number being 1200 or more or 1300 or more results in much higher strength. Alternatively, for example, an area ratio of 2.7% or more, 3.0% or more, or 3.2% or more results in higher strength. In particular, an area ratio of 4.0% or more, 4.5% or more, or 5.0% or more results in much higher strength.

In the case where the first element includes one element selected from the group consisting of Ti, Sc, Zr, Nb, Hf, and Ta, the number of the compound particles in the transverse section tends to increase. For example, the number may be 2000 or more or 2500 or more or, depending on the element, 3000 or more. Such an increased number of the compound particles and an area ratio of 2.5% or more result in finer compound particles that tend to be uniformly dispersed. Thus, the Al alloy wire can have higher strength.

When the number is 4500 or less and the area ratio is 20% or less in the transverse section in the embodiment (c), the compound particles are less likely to block the Al conductive path, thus resulting in high electrical conductivity. This effect is more easily produced when the number is decreased and the area ratio is decreased. For example, the number being 4480 or less, 4200 or less, or 4000 or less results in higher electrical conductivity. Alternatively, for example, an area ratio of 15% or less, 14% or less, or 13% or less results in higher electrical conductivity.

The first Al alloy wire according to an embodiment preferably satisfies the embodiment (c) in addition to at least one of the embodiments (a-1) and (b-1) and at least one of the embodiments (a-2) and (b-2). In particular, when both embodiments (a-2) and (b-2) and the embodiment (c) are satisfied, the compound particles in any cross section are fine and close to spherical, tend to be more uniformly dispersed, and are present in an adequate number. Thus, such an Al alloy wire is preferred because the Al alloy wire can more easily have the strength improving effect due to dispersion strengthening of compound particles and the electrical conductivity improving effect due to the secured Al conductive path and has better mechanical characteristics as described above.

In the second Al alloy wire containing Fe and Nd according to an embodiment, the following measurement regions in the longitudinal section and the transverse section may satisfy the following embodiment (d). The measurement region in the longitudinal section and the measurement region in the transverse section are 5 μm×5 μm square regions.

### Embodiment d

In the measurement region in the longitudinal section and the measurement region in the transverse section, the number of compound particles composed of the compound containing Al, Fe, and Nd is 2200 or more and 3800 or less.

The ratio of the total area of the compound particles to the area of the measurement region in the longitudinal section and the measurement region in the transverse section is 4.5% or more and 20% or less.

In the embodiment (d), the number of the compound particles is almost the same in any direction, and directivity (anisotropy) in the existence of the compound particles is lower than the embodiment (c) or does not substantially exist. Both the number and the area ratio in the embodiment (d) satisfy the above ranges, and each compound particle has a smaller area than in the embodiment (c). Such compound particles are finer. Thus, the Al alloy wire according to the embodiment (d) has higher strength. The Al alloy wire according to the embodiment (d) has at least one effect of lower spring back, improved flexibility, improved fatigue strength, fewer wire breaks due to work hardening, and less breakage due to impact. Furthermore, the finer compound particles are less likely to block the Al conductive path and result in higher electrical conductivity.

When the number is 2200 or more and the area ratio is 4.5% or more in the longitudinal section and the transverse section in the embodiment (d), this results in the appropriate presence of the compound particles and good mechanical characteristics, as described above. This effect is more easily produced when the number is increased and the area ratio is increased. For example, the number being 2250 or more or 2300 or more results in higher strength. Alternatively, for example, an area ratio of 4.6% or more, 4.7% or more, or 5% or more results in higher strength. In particular, an area ratio of 10% or more or 12% or more results in much higher strength.

When the number is 3800 or less and the area ratio is 20% or less in the longitudinal section and the transverse section in the embodiment (d), the compound particles are less likely to block the Al conductive path, thus resulting in high electrical conductivity. This effect is more easily produced when the number is decreased and the area ratio is decreased. For example, the number being 3750 or less or 3700 or less results in higher electrical conductivity. Alternatively, for example, an area ratio of 19.5% or less or 19.0% or less results in higher electrical conductivity.

The second Al alloy wire according to an embodiment preferably satisfies the embodiment (d) in addition to at least one of the embodiments (a-3) and (b-3) and at least one of the embodiments (a-4) and (b-4). In particular, when both embodiments (a-4) and (b-4) and the embodiment (d) are satisfied, the compound particles in any cross section are fine and closer to spherical, tend to be more uniformly dispersed, and are present in an adequate number. Thus, such an Al alloy wire is preferred because the Al alloy wire can more easily have the strength improving effect due to dispersion strengthening of compound particles and the electrical conductivity improving effect due to the secured Al conductive path and has better mechanical characteristics as described above.

### <Amount of Dissolved First Element>

The first element in an Al-based alloy constituting an Al alloy wire according to an embodiment exists mainly as a compound, as described above, and the amount of the first element dissolved in the parent phase is preferably decreased. Quantitatively, in the first Al alloy wire according to an embodiment, the first element content of (the amount of dissolved first element in) the parent phase may be less than 0.55 atomic percent in total. The amount of dissolved first element is an indicator in the quenching state (non-equilibrium state) described later. When the amount of dissolved first element is as very small as 0.55 atomic percent in total, Al in the parent phase has high purity, which results in high electrical conductivity. A smaller amount of dissolved first element results in higher purity of Al and higher electrical conductivity. A smaller amount of dissolved first element results in the presence of the first element in the Al-based alloy as compound particles, appropriate production of the strength improving effect due to dispersion strengthening of the compound particles, and higher strength. When the amount of dissolved first element is 0.53 atomic percent or less or 0.52 atomic percent or less in total, it is easier to produce the electrical conductivity improving effect and the strength improving effect. When the first element is Fe, the amount of dissolved first element of “0.55 atomic percent or less” corresponds to approximately 1% or less by mass on a mass basis.

In the second Al alloy wire containing Fe and Nd according to an embodiment, the Fe content of (the amount of dissolved Fe in) the parent phase may be less than 0.28 atomic percent. A smaller amount of dissolved Fe results in higher electrical conductivity and strength, as described above. When the amount of dissolved Fe is 0.25 atomic percent or less or 0.23 atomic percent or less, it is easier to produce the electrical conductivity improving effect and the strength improving effect.

### <Mechanical Characteristics and Electrical Characteristics>

The first Al alloy wire according to an embodiment has high strength with a tensile strength of 250 MPa or more. The second Al alloy wire containing Fe and Nd according to an embodiment has higher strength with a tensile strength of 345 MPa or more. Such an Al alloy wire is less likely to break when pulled, bent, or repeatedly bent during use. The first Al alloy wire according to an embodiment has higher strength if the first Al alloy wire has a tensile strength of 255 MPa or more, 260 MPa or more, or 265 MPa or more. The second Al alloy wire according to an embodiment has higher strength if the first Al alloy wire has a tensile strength of 350 MPa or more, 360 MPa or more, or 370 MPa or more.

An Al alloy wire according to an embodiment has high electrical conductivity with an electrical conductivity of 50% IACS or more. Such an Al alloy wire is suitable for conductor wires. An electrical conductivity of 51% IACS or more or 52% IACS or more is indicative of higher electrical conductivity. An electrical conductivity of 55% IACS or more, 55.5% IACS or more, 55.8% IACS or more, or 56% IACS or more is indicative of much higher electrical conductivity.

An example of an Al alloy wire according to an embodiment has a 0.2% proof stress of 50 MPa or more. A higher 0.2% proof stress is indicative of higher strength. A 0.2% proof stress of 55 MPa or more, 58 MPa or more, or 60 MPa or more is indicative of much higher strength.

An example of an Al alloy wire according to an embodiment has a 0.2% proof stress of 100 MPa or less, or an elongation at break of 10% or more, or both. In addition to the high tensile strength and electrical conductivity described above, a moderate 0.2% proof stress of 100 MPa or less or a high elongation at break of 10% or more may result in higher flexibility, higher fatigue strength, or less breakage due to impact. An Al alloy wire with a 0.2% proof stress of 100 MPa or less attached to a crimp terminal is less likely to break near the terminal. This is because such an Al alloy wire tends to have an increased terminal coupling strength due to moderate plastic deformation under a crimping load. A 0.2% proof stress of 98 MPa or less, 95 MPa or less, or 90 MPa or less tends to result in much higher flexibility or terminal coupling strength. An elongation at break of 10.5% or more, 11.0% or more, or 11.5% or more tends to result in easier bending. For example, if having an elongation at break of 7% or more, a higher-strength Al alloy wire with a tensile strength of 400 MPa or more has high elongation as well as high strength.

The major-axis length, aspect ratio, number, and area ratio of the compound particles and the tensile strength, 0.2% proof stress, elongation at break, and electrical conductivity of an Al alloy wire can be altered, for example, by adjusting the type of first element, the first element content, the second element (Nd) content, or production conditions (wire drawing conditions, heat-treatment conditions, etc.). For example, a higher first element content tends to result in an increase in major-axis length, aspect ratio, number, or area ratio. A lower first element content has an opposite tendency. A high first element content, for example, tends to result in high tensile strength or 0.2% proof stress. A low first element content tends to result in high electrical conductivity or elongation at break. The first element being Fe and containing Nd tends to result in an increased number or high tensile strength or 0.2% proof stress.

### (Shape)

An Al alloy wire according to an embodiment may have a cross-sectional shape suitable for its use. For example, there are round wires with a circular cross-sectional shape, rectangular wires with a rectangular cross-sectional shape, and deformed wires with a polygonal cross-sectional shape, such as an elliptical or hexagonal cross-sectional shape. An Al alloy wire constituting each wire of the compressed stranded wire described above has a flattened circular cross-sectional shape. The shape of a wire drawing die or the shape of a compression molding die may be determined to achieve the desired cross-sectional shape.

### (Size)

An Al alloy wire according to an embodiment may have a size (cross-sectional area, wire diameter, etc.) suitable for its use. For example, the wire diameter may be 0.01 mm or more and 8 mm or less. The wire diameter refers to the diameter of a round wire or the diameter of the smallest circle surrounding the cross section of a deformed wire. When an Al alloy wire according to an embodiment is used as a conductor of electric wires of various wire harnesses, such as automotive wire harnesses, the wire diameter may be approximately 0.2 mm or more and approximately 1.5 mm or less. When an Al alloy wire according to an embodiment is used as a conductor of electric wires constituting wiring for buildings, the wire diameter may be approximately 0.2 mm or more and approximately 3.6 mm or less. When an Al alloy wire according to an embodiment is used as a signal line of earphones or as a conductor wire of magnet wires, the wire diameter may be 0.01 mm or more and 0.5 mm or less.

### [Al Alloy Stranded Wire]

An Al alloy wire according to an embodiment can be used as a wire of a stranded wire including a compressed stranded wire, as described above. A stranded wire including a high-strength electrically conductive Al alloy wire according to an embodiment has high strength and electrical conductivity. The stranded wire has higher flexibility and can be more easily bent than an Al alloy wire of a solid wire with the same conductor cross-sectional area. The stranded wire may be produced by twisting even fine wires to have high strength as a whole. Thus, each wire is less likely to break upon impact or by repeated bending, and the stranded wire has high impact resistance and fatigue strength. A compressed stranded wire can have a smaller wire diameter than a stranded wire or can have a desired external shape (for example, circular). The number of wires to be twisted, twist pitch, and compressed shape can be appropriately determined.

### [Electric Wire]

An Al alloy wire according to an embodiment or a stranded wire (or compressed stranded wire, the same applies in this paragraph) including an Al alloy wire according to an embodiment is suitable for a conductor of electric wires. The electric wire may be a bare wire or coated wire described below. A solid wire or stranded wire is directly used as a bare wire without an insulating sheath around the wire. The coated wire has an insulating sheath around a solid wire or stranded wire. An electric wire including a high-strength electrically conductive Al alloy wire according to an embodiment as a conductor has high strength and electrical conductivity.

The material of the insulating sheath may be an appropriate insulating material. Examples of the insulating material include poly(vinyl chloride) (PVC), nonhalogenated resins, and flame-retardant materials. Known insulating materials may be used. The insulating sheath may have any thickness, provided that the insulating sheath has a predetermined insulation strength.

The electric wire may be an electric wire with a terminal. The electric wire with a terminal may be used in wire harnesses in automobiles or airplanes or in wire harnesses in industrial robots. The terminal may be a known terminal, such as a crimp terminal or a fusible terminal.

The specifications, such as composition, structure, mechanical characteristics, and electrical characteristics, of an Al alloy wire constituting a conductor of a stranded wire including a compressed stranded wire or a coated electric wire are typically substantially identical with the specifications of an Al alloy wire according to an embodiment before twisting or before the formation of an insulating sheath.

### [Method for Producing Al Alloy Wire]

### (Outline)

The first Al alloy wire according to an embodiment can be produced, for example, by a method for producing the first Al alloy wire according to an embodiment (first production method) including the following material preparing step, wire drawing step, and heat-treatment step. The second Al alloy wire containing Fe and Nd according to an embodiment can be produced, for example, by a method for producing the second Al alloy wire according to an embodiment (second production method) including the following material preparing step, wire drawing step, and heat-treatment step.

### (First Production Method)

(Material Preparing Step) The step of producing a first material composed of an aluminum-based alloy with a composition that contains at least one metallic element (the first element) selected from the group consisting of Fe, Cr, Ni, Co, Ti, Sc, Zr, Nb, Hf, and Ta in the total amount of more than 1.4 atomic percent and 5.1 atomic percent or less and a remainder of Al and incidental impurities, the first element being dissolved in the first material.

(Wire Drawing Step) The step of processing the first material at a temperature lower than or equal to a deposition temperature of the first element to produce a second material, and wiredrawing the second material to produce a wiredrawn product with a predetermined wire diameter.

(Heat-Treatment Step) The step of heat-treating the wiredrawn product to deposit a compound containing Al and the first element.

### (Second Production Method)

(Material Preparing Step) The step of producing a first material composed of an aluminum-based alloy with a composition that contains more than 1.4 atomic percent and 5.1 atomic percent or less Fe, more than 0.006 atomic percent and 0.1 atomic percent or less Nd, and a remainder of Al and incidental impurities, the Fe and Nd being dissolved in the first material.

(Wire Drawing Step) The step of processing the first material at a temperature lower than or equal to a deposition temperature of Fe and Nd to produce a second material, and wiredrawing the second material to produce a wiredrawn product with a predetermined wire diameter.

(Heat-Treatment Step) The step of heat-treating the wiredrawn product to deposit a compound containing Al, Fe, and Nd.

In the first production method, although the first element content is more than 1.4 atomic percent in total and is relatively high, a material to be wire-drawn is substantially free of a deposit of the first element. Typically, the material to be wire-drawn is a second material prepared by processing a first material under the conditions that no first element is substantially deposited. The first element is substantially entirely dissolved in the first material. The second material does not substantially contain a compound containing Al and the first element before wire drawing. Thus, no breakage occurs from the compound particles in wire drawing, thus resulting in high wire drawability. Wire-drawing such a second material has fewer wire breaks during wire drawing and improves the productivity of the wiredrawn product. The compound can be deposited as fine particles by heat treatment after wire drawing. Thus, the first production method can form a structure in which fine compound particles are dispersed and can decrease the amount of the first element dissolved in the parent phase. Thus, the first production method can productively produce a high-strength electrically conductive Al alloy wire, typically the first Al alloy wire according to an embodiment.

In the second production method, although the Al-based alloy contains more than 1.4 atomic percent Fe and Nd, a material to be wire-drawn is substantially free of deposits of Fe and Nd. Typically, the material to be wire-drawn is a second material prepared by processing a first material under the conditions that neither Fe nor Nd is substantially deposited. Fe and Nd are substantially entirely dissolved in the first material. The second material also has high wire drawability for the above reason. Heat treatment after wire drawing can deposit the compound containing Al, Fe, and Nd as very fine particles. Thus, the second production method can form a structure in which finer compound particles are dispersed and can decrease the amount of Fe and Nd dissolved in the parent phase. Thus, the second production method can productively produce a higher-strength electrically conductive Al alloy wire, typically the second Al alloy wire according to an embodiment.

These steps will be described in detail below.

### (Material Preparing Step)

In this step, typically, a melt composed of the Al-based alloy is quenched to produce the first material. The first material is typically a supersaturated solid solution in which the first element or Fe and Nd (hereinafter also collectively referred to as the first element and optional elements) are dissolved.

In a known continuous casting method as described in Patent Literature 1, the cooling rate of a melt in casting is 1000° C./s or less, practically hundreds of degrees per second or less. Solidification of a melt, for example, containing 3% or more by mass Fe at such a cooling rate deposits a compound containing Al and Fe in casting, thus producing a cast product containing the compound. In particular, due to the high Fe content of 3% or more by mass, the compound tends to be coarse particles or an agglomerate. In a method for producing an Al alloy wire according to an embodiment, considering the first element content of more than 1.4 atomic percent (3% or more by mass for Fe), the cooling rate of the melt is higher than that in the known continuous casting method. Qualitatively, the cooling rate of the melt is such that the first element and optional elements are not substantially deposited. Quantitatively, the cooling rate of the melt is 10,000° C./s or more.

A higher cooling rate of the melt results in a lower likelihood of deposition of the first element and optional elements. Thus, a supersaturated solid solution substantially free of a deposit composed of a compound containing Al and the first element and optional elements is easily produced. For example, in the structural analysis by X-ray diffraction (XRD), the ratio of the top peak intensity of Al to the top peak intensity of the compound (the top peak intensity of Al/the top peak intensity of the compound) corresponds theoretically to the volume ratio, on the assumption that the solid solution element (the first element and optional elements) is entirely deposited. At this ideal ratio, there is not much difference between the denominator and the numerator. In contrast, in the ratio in the first material, the denominator (the top peak intensity of the compound) is much smaller than the numerator (the top peak intensity of Al), and the ratio is high. Thus, the first material tends to be a cast product with the ratio being high. For example, the ratio of the cast product tends to be 10 times or more, 12 times or more, or 15 times or more of the theoretical ratio. When the cooling rate of the melt is 15,000° C./s or more, 20,000° C./s or more, or 50,000° C./s or more, the deposition of the compound can be more effectively reduced. Thus, the ratio in the first material can be easily increased.

The cooling rate of the melt may be adjusted for the composition of the melt, the temperature of the melt, and the size (thickness, particle size, etc.) of the solidified product. The cooling rate is determined, for example, by measuring the temperature of the melt in contact with a mold (for example, a copper roll in a melt-spun method described later) with a high-sensitivity infrared thermographic camera (for example, A6750 manufactured by FLIR Systems, Inc., temporal resolution: 0.0002 s). The cooling rate is calculated by (the temperature of the melt−300)/t (° C./s), wherein t denotes the elapsed time (s) of cooling from the temperature of the melt to 300° C. For example, if the temperature of the melt is 700° C., the cooling rate is 400/t (° C./s).

For the first material in thin band-like or powder form, the small thickness or particle size tends to result in a cooling rate of 10,000° C./s or more. A method for producing a thin belt-like first material is a melt-spun method, for example. A method for producing a powdered first material is an atomization process, particularly a gas atomization process using argon gas, for example. A thin linear first material may be produced by a melt spinning process.

In the melt-spun method, a raw material melt is sprayed and quenched on a cooling medium, such as a high-speed rotating metal roll or metal disk, to produce a thin band or flakes (formed by breaking a thin band). In the melt-spun method, the cooling rate of the melt depends on the amount of the first element and optional elements or the thickness of the thin band and may be 100,000° C./s or more or 1,000,000° C./s or more.

In the atomization process, a raw material melt flowing through small openings at the bottom of a crucible is scattered and quenched by high-pressure-sprayed gas with high cooling power or by high-pressure-sprayed water to produce a powder. In the atomization process, the cooling rate of the melt depends on the amount of the first element and optional elements or the gas pressure and may be 50,000° C./s or more or 100,000° C./s or more.

The thin band or flakes have a thickness of 1 μm or more and 100 μm or less, 50 μm or less, or 40 μm or less, for example. The atomized powder has a diameter of 1 μm or more and 20 μm or less, 10 μm or less, or 5 μm or less, for example.

### (Wire Drawing Step)

In this step, first, the first material is processed under the conditions that no first element or optional elements are substantially deposited, more specifically, at a temperature lower than or equal to the deposition temperature of the first element and optional elements to produce a second material. The second material produced by processing under the particular conditions may be wire-drawn to produce a wiredrawn product. The second material preferably has a final relative density of 98% or more. The relative density is the apparent density relative to the true density. A high density with a relative density of 98% or more can result in the second material with a small inner space. This reduces breakage caused by stress concentration in the space during wire drawing. This consequently facilitates wire drawing.

### <Material to be Wire-Drawn>

The second material may be a rolled product formed by rolling the thin band or a rolled product formed by powder-rolling the flakes or powder. A long second material can be produced by rolling. A dense second material can be produced by plastic working, such as rolling. Wire drawing of a long dense second material is easy to perform as described above.

Another example of the second material is a compression product produced by pressing flakes or a powder during heating at a temperature at which the first element and optional elements are not substantially deposited. Compression by pressurization can reduce the inner space and enables densification. Wire drawing of such a compression product is easy to perform as described above. Thus, a compression product is suitable for a material used in the production of, for example, a thin wire with a small final diameter, particularly a thin wire with a diameter of 1 mm or less. The temperature depends on the type of first element and optional elements and may be (heating temperature−50) ° C. or less or (heating temperature−60) ° C. or less, wherein the heating temperature is one in the heat-treatment step described later. For the first element Fe, the temperature may be 300° C. or more and 400° C. or less or 380° C. or less. The pressure to be applied may be such that the relative density is 90% or more, 95% or more, or 98% or more, for example. Quantitatively, the pressure to be applied is 50 MPa or more, 100 MPa or more, or 700 MPa or more, for example. The pressure to be applied may be 1500 MPa or less in order to prevent cracks caused by expansion of the inner space of the second material or to improve the durability of the forming die. A compression product may be produced under such conditions by hot pressing. Alternatively, a compression product may be produced as a solid phase sintered body by spark plasma sintering (SPS) in an argon atmosphere or by hot isostatic pressing (HIP).

Another example of the second material is the thin band, flakes, or powder described above, or a sealed product prepared by putting the compression product into a metal tube and sealing each end of the metal tube. Even when a powder is used, the sealed product can prevent scattering of the powder. The sealed product even containing a fragile material can easily maintain its shape. Thus, the sealed product is easily wire-drawn and is suitable for the thin wire, particularly a thin wire with a diameter of 1 mm or less. The metal tube can be made of an appropriate metal that has workability enough for plastic working, such as wire drawing or extrusion described later, and strength with which the sealed product can be prevented from collapsing in plastic working. For example, the metal tube is made of pure aluminum, an aluminum alloy (for example, JIS standard, alloy No. A1070, etc.), pure copper, or a copper alloy. The surface layer of the metal tube may be removed or left after wire drawing. The surface layer may be left to produce a coated Al alloy wire having the surface layer as a covering layer, for example, a copper coated Al alloy wire. The size of the metal tube may depend on the amount and size of the contents or the thickness of the covering layer when the surface layer serves as the covering layer.

Another example of the second material is the compression product or an extruded product of the sealed product. Extrusion enables densification. For example, the extruded product has a relative density of 98% or more, 99% or more, or substantially 100%, depending on the material before extrusion or the extrusion conditions. Such densification facilitates wire drawing of the extruded product, which is suitable for a material of the thin wire. In particular, the extruded product of the sealed product containing the compression product has a higher density and is suitable for a material of the thin wire. The extrusion temperature may be any temperature at which the first element and optional elements are not substantially deposited. The extrusion temperature depends on the type of first element and may be (heating temperature−20) ° C. or less or (heating temperature−30) ° C. or less, wherein the heating temperature is one in the heat-treatment step described later. For the first element Fe, the extrusion temperature may be 300° C. or more and 400° C. or less or 380° C. or less.

### <Wire Drawing>

Wire drawing is typically cold working, and a wire drawing die may be used. The wire drawing conditions (the working ratio per pass, the total working ratio, etc.) are appropriately selected according to the composition or size of the first or second material such that the wiredrawn product can have a predetermined final wire diameter. Reference may be made to known wire drawing conditions.

### <Intermediate Heat Treatment>

Intermediate heat treatment may be performed during wire drawing before the wiredrawn product has a predetermined final wire diameter. The intermediate heat treatment aims primarily to relieve a strain caused by wire drawing and is performed to improve wire drawability after the intermediate heat treatment. The intermediate heat treatment is also performed under the conditions that the first element and optional elements are not substantially deposited. The heating temperature in the intermediate heat treatment depends on the type of first element and optional elements. For example, for the first element Fe and in batch treatment (described later), the heating temperature may be 300° C. or more and 400° C. or less or 380° C. or less. The holding time in the intermediate heat treatment may be 0.5 hours or more and 3 hours or less.

### (Heat-Treatment Step)

In this step, the wiredrawn product is heat-treated to deposit a compound containing Al and the first element and optional elements, thereby producing an Al alloy wire with a structure in which the compound is dispersed. To this end, the first element and optional elements can be deposited under the heat-treatment conditions in the heat-treatment step. In the first production method, the heat-treatment conditions are adjusted so that the tensile strength can be 250 MPa or more and the electrical conductivity can be 50% IACS or more. In the second production method, the heat-treatment conditions are adjusted so that the tensile strength can be 345 MPa or more and the electrical conductivity can be 50% IACS or more. The heat-treatment conditions are preferably adjusted so that the tensile strength and the electrical conductivity can satisfy the above particular range and so that an elongation at break of 10% or more, or a 0.2% proof stress of 50 MPa or more and 100 MPa or less, or both can be satisfied. The heat treatment may be batch treatment or continuous treatment.

In the batch treatment, an object to be heat-treated in a heating vessel, such as an atmosphere furnace, is heated. In the batch treatment, the heating temperature is 300° C. or more, for example. The heating temperature may be adjusted for the type and amount of the first element and optional elements. For example, the heating temperature is set as described below. A binary Al-based alloy containing one of the first elements in an amount of 1.5 atomic percent to 1.6 atomic percent is heat-treated at a different heating temperature after wire drawing. The electrical conductivity and tensile strength of the Al-based alloy are measured after heat treatment. In general, the electrical conductivity and the tensile strength vary with the heating temperature. Typically, an increased heating temperature results in a decreased amount of dissolved first element and optional elements and improved electrical conductivity. The deposition of the first element and optional elements improves the electrical conductivity and tensile strength. Above a certain temperature, the electrical conductivity levels off, and the tensile strength decreases due to softening. The heating temperature is determined on the basis of the temperature at which an improvement in electrical conductivity is saturated and the strength is highest. The same holds for those containing Nd.

Examples of the heating temperature are described below.

For the first element Fe or for those containing Fe and Nd, the heating temperature may be approximately more than 400° C., or approximately 420° C. or more and approximately 500° C. or less.

For the first element Cr, Ni, or Ta, the heating temperature may be approximately 350° C. or more, or approximately 370° C. or more and approximately 450° C. or less.

For the first element Co, the heating temperature may be approximately 400° C. or more, or approximately 420° C. or more and approximately 500° C. or less.

For the first element Ti, the heating temperature may be approximately 475° C. or more, or approximately 500° C. or more and approximately 580° C. or less.

For the first element Sc, the heating temperature may be approximately 300° C. or more and approximately 500° C. or less.

For the first element Zr, the heating temperature may be 500° C. or more, or approximately 520° C. or more and approximately 600° C. or less.

For the first element Nb, the heating temperature may be 525° C. or more, or approximately 550° C. or more and approximately 600° C. or less.

For the first element Hf, the heating temperature may be 325° C. or more, or approximately 350° C. or more and approximately 500° C. or less.

The holding time may be approximately 10 seconds or more and approximately 6 hours or less. At a higher heating temperature, the first element and optional elements can be more easily deposited even in a short holding time. A shorter holding time results in improved productivity.

Typically, an Al alloy wire with tensile strength, electrical conductivity, elongation at break, and 0.2% proof stress in the particular ranges can be produced by heat treatment at the heating temperature for the holding time described above.

In particular, for the first element Fe or for those containing Fe and Nd, the heating temperature is more preferably 450° C. or more, 460° C. or more, or 470° C. or more to improve productivity. At a heating temperature of 450° C. or more, the holding time may be 3 hours or less, 2 hours or less, or 1.5 hours (90 minutes) or less, depending on the Fe or Nd content or the wire diameter.

In the continuous treatment, an object to be heat-treated is continuously supplied to and heated in a heating vessel, such as a pipe furnace or an electric furnace. In the continuous treatment, parameters, such as the current value, linear velocity, and furnace size, may be adjusted so that the wire after heat treatment can have electrical conductivity and tensile strength in the above ranges.

The atmosphere in the heat treatment is the air atmosphere or a hypoxic atmosphere, for example. The air atmosphere obviates the need for atmospheric control and provides good heat treatment workability. The hypoxic atmosphere has a lower oxygen content than the atmosphere and can reduce the surface oxidation of an Al-based alloy. The hypoxic atmosphere may be a vacuum atmosphere (reduced pressure atmosphere), an inert gas atmosphere, or a reducing gas atmosphere.

To produce the stranded wire, heat-treated products subjected to the heat-treatment step may be twisted together, or wiredrawn products subjected to the wire drawing step may be twisted together and subjected to heat treatment in the heat-treatment step. To produce a compressed stranded wire, the heat-treated products may be twisted together and compressed, or the wiredrawn products may be twisted together, subjected to the heat treatment, and compressed, or the wiredrawn products may be twisted together, compressed, and subjected to the heat treatment.

### Test Example 1

Al alloy wires with the following compositions were produced under the following two conditions and were examined in terms of mechanical characteristics, electrical characteristics, and structure. Tables 1 to 20 show the results. Tables 1 and 2 list samples containing Fe or samples containing Fe and Nd. Tables 3 and 4 list samples containing Cr. Tables 5 and 6 list samples containing Ni. Tables 7 and 8 list samples containing Co. Tables 9 and 10 list samples containing Ti. Tables 11 and 12 list samples containing Sc. Tables 13 and 14 list samples containing Zr. Tables 15 and 16 list samples containing Nb. Tables 17 and 18 list samples containing Hf Tables 19 and 20 list samples containing Ta.

### (Sample by Melt-Quenching Method)

Al alloy wires of sample No. 1 to No. 19, No. 31 to No. 34, No. 41 to No. 44, No. 51 to No. 54, No. 61 to No. 64, No. 71 to No. 74, No. 81 to No. 84, No. 91 to No. 94, No. 101 to No. 104, No. 111 to No. 114 are produced as described below. These samples are hereinafter also referred to as a quenching method sample group.

A binary Al-based alloy (master alloy) of pure aluminum (purity 4N) and a pure metal (purity 3N) or of aluminum and a pure metal is prepared as a raw material. The pure metal refers to a metallic element described in “First element Type” or “Second element Type” in tables with odd numbers among Tables 1 to 20. The master alloy can be produced by a known production method, for example, using a graphite electric furnace, a high-frequency melting furnace, or an arc melting furnace. A melt of the Al-based alloy is prepared by adjusting the amount of pure metal to be added or the amount of master alloy to be added for the first element content (% by mass or atomic percent) listed in the tables with odd numbers. A melt of the Al-based alloy containing the first element or a melt of the Al-based alloy containing the first element and the second element (Nd) is prepared. The melt thus prepared is used to prepare a thin band (solid solution material) by the melt-spun method (melt-quenching method).

The first element content (% by mass or atomic percent) is the ratio of the first element to 100% by mass or 100 atomic percent of the Al-based alloy. The second element (Nd) content (% by mass) is the ratio of Nd to 100% by mass of the Al-based alloy. The Nd content (atomic percent) is the ratio of Nd to 100 atomic percent of Al and Nd in total or the ratio of Nd to 100 atomic percent of the Al-based alloy.

The raw material is heated to 900° C. in a reduced-pressure argon atmosphere (−0.02 MPa) to prepare a melt. The melt is sprayed on a copper roll rotating at a surface peripheral speed of 50 m/s to prepare a thin band. The thin band has a width of approximately 2 mm and a thickness of approximately 30 μm. The thin band has an arbitrary length. The cooling rate of the melt ranges from 80,000° C./s to 100,000° C./s (≥10,000° C./s).

The thin band of each sample was subjected to XRD structural analysis and cross-sectional observation with a scanning electron microscope (SEM).

The XRD structural analysis shows that the thin bands of the samples No. 1 to No. 18 and the thin bands of the samples with the last digit of the sample number ranging from 1 to 3 among the samples of No. 31 and above substantially have an Al single phase, though a peak of a compound containing Al and the first element and optional elements is observed. Thus, the thin bands of these samples have an Al crystal structure. An Al peak is at least 20 times the peak of the compound. The specific compositions of the compounds are listed in “Compound composition” in tables with even numbers among Tables 1 to 20. The SEM observation of a cross section of each thin band of these samples shows no compound more than 100 nm in size and substantially shows a Al single phase.

The XRD structural analysis shows that the peak of the compound in the thin band of the sample No. 19 and in the thin bands of the samples with the last digit of the sample number being 4 among the samples of No. 31 and above is more than 5% (approximately 7% to 10%) of the Al peak, though the Al peak is at least 10 times the peak of the compound. In these samples, the first element and optional elements content exceeds the amount of solid soluble in Al (for example, 10% by mass for Fe), and the first element and optional elements are deposited.

Thus, if the first element and optional elements content is appropriate, and an appropriate method, such as the melt-spun method, is used, a first material (thin band) in which the first element and optional elements are not substantially deposited and in which the first element and optional elements are substantially entirely dissolved can be produced.

The thin band is appropriately pulverized into a powder, and the powder is pressed during heating to prepare a compression product. In this example, hot pressing is performed in an argon atmosphere at a pressure of 0.1 GPa and at the following heating temperature (° C.) for a holding time of 60 minutes. The heating temperature for the samples containing the first element Fe and the samples containing Fe and Nd is 350° C. The heating temperature for the other samples is (heating temperature in heat treatment−60) ° C. The heat treatment is performed after wire drawing described later. A cylindrical compression product with a diameter of 10 mmϕ and a length of 10 mm is prepared by the hot pressing. The compression product of each sample has a relative density of 95%. The relative density is calculated from the apparent density and true density of the compression product by (apparent density/true density)×100.

Among the compression products of the samples, the samples No. 1 to No. 18 and the samples with the last digit of the sample number ranging from 1 to 3 among the samples of No. 31 and above were subjected to XRD structural analysis. The compression products of these samples substantially have an Al single phase, though a peak of a compound containing Al and the first element and optional elements is observed. An Al peak is 15 times or more and not more than 20 times the peak of the compound. The SEM observation of a transverse section of each compression product of these samples shows no compound more than 100 nm in size and substantially shows an Al single phase. Thus, in the compression product produced by processing the thin band at a temperature lower than or equal to the deposition temperature of the first element and optional elements, the first element and optional elements are not substantially deposited, and the first element and optional elements are substantially entirely dissolved.

The compression product of each sample is inserted into an aluminum tube, and the aluminum tube is sealed at each end to prepare a sealed product. The sealed product is extruded to prepare an extruded product. The aluminum tube has an inner diameter of 10 mmϕ and an outer diameter of 12 mmϕ and is made of a 1000 series aluminum alloy (JIS standard, alloy No. A1070). A1070 has higher plastic formability than the thin band made of the Al-based alloy. The tube is sealed in an argon atmosphere.

The extrusion is performed with a hydraulic extruder. The extrusion temperature for the samples containing the first element Fe and the samples containing Fe and Nd is 400° C. The extrusion temperature for the other samples is (heating temperature in heat treatment−30)° C. The heat treatment is performed after wire drawing described later. The extruded product is a round bar with a diameter of 3 mmϕ. After extrusion, the surface layer composed of the aluminum tube is removed by cutting. Also in the extruded product formed under the above extrusion conditions, the first element and optional elements are not substantially deposited, and the first element and optional elements are substantially entirely dissolved.

After the surface layer is removed, the extruded product (second material) of each sample is wire-drawn to prepare a wiredrawn product. The wire drawing is cold working with a wire drawing die. The wiredrawn product has the final wire diameter (0.5 mmϕ).

The wiredrawn product of each sample is heat-treated. The heat treatment is batch treatment in a nitrogen atmosphere at the following heating temperature (° C.) for a holding time of 60 minutes.

### <Heating Temperature of Each Sample in Heat-Treatment Step>

The samples containing the first element Fe and the samples containing Fe and Nd: 475° C.

The samples containing the first elements Cr, Ni, and Ta: 400° C.

The samples containing the first element Co: 450° C.

The samples containing the first element Ti: 525° C.

The samples containing the first element Sc: 300° C.

The samples containing the first element Zr: 550° C.

The samples containing the first element Nb: 575° C.

The samples containing the first element Hf: 375° C.

### (Samples by Mold Casting Method)

Al alloy wires of sample No. 20 to No. 26, No. 35 to No. 38, No. 45 to No. 48, No. 55 to No. 58, No. 65 to No. 68, No. 75 to No. 78, No. 85 to No. 88, No. 95 to No. 98, No. 105 to No. 108, and No. 115 to No. 118 are produced as described below. These samples are hereinafter also referred to as a casting method sample group.

A melt of the Al-based alloy containing the first element and optional elements is prepared in the same manner as in the sample No. 1 and other samples, and a continuous cast product is produced by a known continuous casting method (mold casting method). A copper mold is used to prepare a round-bar-shaped continuous cast product with a diameter of 10 mmϕ, and a length of 30 mm. The continuous cast product is extruded to prepare an extruded product. The extrusion is performed with a hydraulic extruder. The extrusion temperature is adjusted for the type of first element in the same manner as in the sample No. 1 and other samples (the samples containing Fe: 400° C., the other samples: (the heating temperature in the heat-treatment step−30) ° C.). The extruded product is a round bar with a diameter of 3 mmϕ. The extruded product is wire-drawn to prepare a wiredrawn product with the final wire diameter (0.5 mmϕ). The wire drawing is cold working with a wire drawing die. The wiredrawn product of each sample is heat-treated in the same manner as in the sample No. 1 and other samples. The heating temperature in the heat-treatment step is adjusted for the type of first element and optional elements, as described above.

### (Mechanical Characteristics and Electrical Characteristics)

The heat-treated product (0.5 mmϕ wire) of each sample is measured for electrical conductivity (% IACS), tensile strength (MPa), 0.2% proof stress (MPa), and elongation at break (%). The tables with odd numbers among Tables 1 to 20 list the measurement results.

The electrical conductivity (% IACS) is measured by a bridge method. The tensile strength (MPa), 0.2% proof stress (MPa), and elongation at break (%) are measured according to JIS Z 2241 (Metallic materials—Tensile testing—Method of test at room temperature, 1998) with a general-purpose tensile tester.

### (Structure Observation)

### <Compound Particles>

The following cross sections of the heat-treated product (0.5 mmϕ wire) of each sample are observed with a microscope at an appropriate magnification (for example, 10,000 times). One of the cross sections is a longitudinal section cut in a plane in the axial direction (longitudinal direction) of the wire. Another of the cross sections is a transverse section cut in a plane perpendicular to the axial direction of the wire. Although the observation is performed herein with a SEM, a metallographic microscope may also be used. The heat-treated product of any sample has a structure in which particles composed of a compound containing Al and the first element and optional elements (for example, Al₁₃Fe₄) are dispersed in the parent phase in both the longitudinal section and the transverse section.

The major-axis length (nm) and aspect ratio of the compound particles and the number and area ratio (%) of the compound particles in a specified measurement region are measured in the longitudinal section and in the transverse section, as described below.

At least one longitudinal section and at least one transverse section are selected in the heat-treated product of each sample. At least ten 5 μm×5 μm square measurement regions are selected in each of the longitudinal section and the transverse section. Alternatively, a plurality of longitudinal sections and transverse sections may be selected, and one or two or more measurement regions may be selected in each cross section. At least ten measurement regions may be selected in each longitudinal section, and at least ten measurement regions may be selected in each transverse section.

All the compound particles in each measurement region in the longitudinal section are extracted. The major-axis length (nm) of each compound particle is the maximum length of the compound particle. The major-axis lengths of all the compound particles are determined and averaged. The average is taken as the major-axis length in the longitudinal section. Likewise, the major-axis length in the transverse section is determined. The tables with even numbers among Tables 1 to 20 list the results. The maximum length, minimum length described later, number, and area ratio can be easily measured with a commercial image-processing apparatus. For example, the area ratio can be easily measured with an image-processing apparatus for performing appropriate processing, such as binarization.

The aspect ratio of a compound particle is the ratio of the major-axis length to the minor-axis length of the compound particle (major-axis length/minor-axis length). The minor-axis length (nm) of a compound particle is the maximum length of a line segment perpendicular to the longest straight line of the compound particle. The aspect ratio of a compound particle is calculated from the minor-axis length and major-axis length of the compound particle. The aspect ratios of all the compound particles in each measurement region in the longitudinal section are determined and averaged. The average is taken as the aspect ratio in the longitudinal section. Likewise, the aspect ratio in the transverse section is determined. The tables with even numbers among Tables 1 to 20 list the results.

The number of all the compound particles in each measurement region in the longitudinal section is determined and averaged. The number in the transverse section is also determined in the same manner. The tables with even numbers among Tables 1 to 20 list the results.

The area ratio (%) is the percentage of the total area of all the compound particles in one measurement region to the area of the measurement region (5 μm×5 μm=25 μm²). Thus, the area ratio (%) is (the total area of the compound particles/the area of the measurement region)×100. The area ratio of each measurement region in the longitudinal section is determined and averaged. The average is taken as the area ratio in the longitudinal section. Likewise, the area ratio in the transverse section is determined. The tables with even numbers among Tables 1 to 20 list the results.

### <Composition of Compound>

The structure of a compound is examined by XRD structural analysis in the longitudinal or transverse section. The tables with even numbers among Tables 1 to 20 list the results. The constituent elements of the compound are identified. The identification may be performed with local component analysis equipment, such as a transmission electron microscope (TEM) equipped with an energy dispersive X-ray spectroscopy (EDX) measuring apparatus. TEM-EDX is used herein. The identification shows that the samples containing Fe and Nd contains Nd in a compound containing Fe and Al.

### <Amount of Dissolved First Element>

The first element content (% by mass or atomic percent) of the parent phase is measured in a longitudinal or transverse section of the heat-treated product of each sample. The measurement may be performed with local component analysis equipment, such as TEM-EDX. TEM-EDX is used herein. The parent phase is extracted from a TEM image to determine the first element content of the parent phase. At least ten measurement regions are selected in one cross section. The first element content in each measurement region is determined and averaged. The average is taken as the first element content of the parent phase and is listed in the tables with odd numbers among Tables 1 to 20.

TABLE 1

| | | First element | | | | | | | | | | | | |
|---|---|---|---|---|---|---|---|---|---|---|---|---|---|---|
| | | | | | Solid | Solid | | | | | Elec- | | | Elon- |
| | | | | | solution | solution | Second element | | | | trical | | 0.2% | gation |
| | | | | | content of | content of | | | Ratio | Ratio to | conduc- | Tensile | proof | at |
| Sample | Casting | | Content | Content | Al phase | Al phase | | Content | to Al | alloy | tivity | strength | stress | break |
| No. | method | Type | (mass %) | (at %) | (mass %) | (at %) | Type | (mass %) | (at %) | (at %) | (IACS %) | (MPa) | (%) | (%) |
| 1 | Liquid | Fe | 2 | 0.98 | 0.60 | 0.29 | — | — | — | — | 60 | 160 | 65 | 18 |
| | quenching | | | | | | | | | | | | | |
| | method | | | | | | | | | | | | | |
| 2 | Liquid | Fe | 3 | 1.47 | 0.63 | 0.31 | — | — | — | — | 59 | 250 | 65 | 17 |
| | quenching | | | | | | | | | | | | | |
| | method | | | | | | | | | | | | | |
| 3 | Liquid | Fe | 3 | 1.47 | 0.58 | 0.28 | Nd | 0.03 | 0.006 | 0.006 | 57 | 260 | 67 | 17 |
| | quenching | | | | | | | | | | | | | |
| | method | | | | | | | | | | | | | |
| 4 | Liquid | Fe | 3 | 1.47 | 0.34 | 0.16 | Nd | 0.05 | 0.009 | 0.010 | 54 | 345 | 88 | 15 |
| | quenching | | | | | | | | | | | | | |
| | method | | | | | | | | | | | | | |
| 5 | Liquid | Fe | 3 | 1.47 | 0.30 | 0.15 | Nd | 0.50 | 0.094 | 0.095 | 53 | 398 | 94 | 10 |
| | quenching | | | | | | | | | | | | | |
| | method | | | | | | | | | | | | | |
| 6 | Liquid | Fe | 3 | 1.47 | 0.28 | 0.14 | Nd | 0.75 | 0.141 | 0.143 | 49 | 410 | 103 | 7 |
| | quenching | | | | | | | | | | | | | |
| | method | | | | | | | | | | | | | |
| 7 | Liquid | Fe | 4 | 1.97 | 0.65 | 0.32 | — | — | — | — | 57 | 280 | 70 | 16 |
| | quenching | | | | | | | | | | | | | |
| | method | | | | | | | | | | | | | |
| 8 | Liquid | Fe | 6 | 2.99 | 0.65 | 0.32 | — | — | — | — | 56 | 290 | 70 | 14 |
| | quenching | | | | | | | | | | | | | |
| | method | | | | | | | | | | | | | |
| 9 | Liquid | Fe | 6 | 2.99 | 0.63 | 0.31 | Nd | 0.03 | 0.006 | 0.006 | 53 | 295 | 73 | 14 |
| | quenching | | | | | | | | | | | | | |
| | method | | | | | | | | | | | | | |
| 10 | Liquid | Fe | 6 | 2.99 | 0.40 | 0.19 | Nd | 0.05 | 0.009 | 0.010 | 52 | 370 | 93 | 12 |
| | quenching | | | | | | | | | | | | | |
| | method | | | | | | | | | | | | | |
| 11 | Liquid | Fe | 6 | 2.99 | 0.33 | 0.16 | Nd | 0.50 | 0.094 | 0.097 | 51 | 420 | 98 | 10 |
| | quenching | | | | | | | | | | | | | |
| | method | | | | | | | | | | | | | |
| 12 | Liquid | Fe | 6 | 2.99 | 0.30 | 0.15 | Nd | 0.75 | 0.141 | 0.146 | 46 | 441 | 112 | 6 |
| | quenching | | | | | | | | | | | | | |
| | method | | | | | | | | | | | | | |
| 13 | Liquid | Fe | 8 | 4.03 | 0.69 | 0.33 | — | — | — | — | 56 | 310 | 75 | 12 |
| | quenching | | | | | | | | | | | | | |
| | method | | | | | | | | | | | | | |
| 14 | Liquid | Fe | 10 | 5.09 | 0.71 | 0.34 | — | — | — | — | 55 | 330 | 85 | 10 |
| | quenching | | | | | | | | | | | | | |
| | method | | | | | | | | | | | | | |
| 15 | Liquid | Fe | 10 | 5.09 | 0.66 | 0.32 | Nd | 0.03 | 0.006 | 0.006 | 55 | 326 | 88 | 10 |
| | quenching | | | | | | | | | | | | | |
| | method | | | | | | | | | | | | | |
| 16 | Liquid | Fe | 10 | 5.09 | 0.45 | 0.22 | Nd | 0.05 | 0.009 | 0.010 | 53 | 411 | 97 | 9 |
| | quenching | | | | | | | | | | | | | |
| | method | | | | | | | | | | | | | |
| 17 | Liquid | Fe | 10 | 5.09 | 0.36 | 0.17 | Nd | 0.50 | 0.094 | 0.099 | 50 | 442 | 100 | 7 |
| | quenching | | | | | | | | | | | | | |
| | method | | | | | | | | | | | | | |
| 18 | Liquid | Fe | 10 | 5.09 | 0.33 | 0.16 | Nd | 0.75 | 0.141 | 0.149 | 46 | 475 | 128 | 3 |
| | quenching | | | | | | | | | | | | | |
| | method | | | | | | | | | | | | | |
| 19 | Liquid | Fe | 12 | 6.18 | 0.73 | 0.35 | — | — | — | — | 49 | 360 | 130 | 3 |
| | quenching | | | | | | | | | | | | | |
| | method | | | | | | | | | | | | | |
| 20 | Mold | Fe | 2 | 0.98 | 0.28 | 0.14 | — | — | — | — | 59 | 120 | 50 | 16 |
| | casting | | | | | | | | | | | | | |
| | method | | | | | | | | | | | | | |
| 21 | Mold | Fe | 3 | 1.47 | 0.38 | 0.18 | — | — | — | — | 58 | 130 | 55 | 12 |
| | casting | | | | | | | | | | | | | |
| | method | | | | | | | | | | | | | |
| 22 | Mold | Fe | 4 | 1.97 | 0.51 | 0.25 | — | — | — | — | 54 | 160 | 65 | 10 |
| | casting | | | | | | | | | | | | | |
| | method | | | | | | | | | | | | | |
| 23 | Mold | Fe | 6 | 2.99 | 0.52 | 0.25 | — | — | — | — | 51 | 220 | 85 | 3 |
| | casting | | | | | | | | | | | | | |
| | method | | | | | | | | | | | | | |
| 24 | Mold | Fe | 8 | 4.03 | 0.55 | 0.27 | — | — | — | — | 48 | 260 | 120 | 2 |
| | casting | | | | | | | | | | | | | |
| | method | | | | | | | | | | | | | |
| 25 | Mold | Fe | 10 | 5.09 | 0.54 | 0.26 | — | — | — | — | 42 | 300 | 145 | 2 |
| | casting | | | | | | | | | | | | | |
| | method | | | | | | | | | | | | | |
| 26 | Mold | Fe | 12 | 6.18 | 0.55 | 0.27 | — | — | — | — | 40 | 320 | 160 | 2 |
| | casting | | | | | | | | | | | | | |
| | method | | | | | | | | | | | | | |

TABLE 2

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 1 | Al₁₃Fe₄ | 70 | 2.1 | 210 | 0.65% | 110 | 2.7 | 210 | 1.25% |
| 2 | Al₁₃Fe₄ | 85 | 2.0 | 1,132 | 5.45% | 110 | 2.8 | 961 | 5.54% |
| 3 | Al₁₃Fe₄(containing Nd) | 71 | 2.0 | 1,685 | 5.66% | 104 | 3.3 | 1,210 | 5.29% |
| 4 | Al₁₃Fe₄(containing Nd) | 52 | 1.9 | 2,780 | 5.28% | 70 | 2.8 | 2,274 | 5.31% |
| 5 | Al₁₃Fe₄(containing Nd) | 48 | 1.9 | 2,950 | 4.77% | 61 | 2.7 | 2,660 | 4.89% |
| 6 | Al₁₃Fe₄(containing Nd) | 62 | 1.9 | 2,330 | 6.29% | 84 | 2.6 | 1,348 | 4.88% |
| 7 | Al₁₃Fe₄ | 100 | 2.2 | 1,264 | 7.66% | 130 | 2.8 | 1,054 | 8.48% |
| 8 | Al₁₃Fe₄ | 120 | 2.4 | 1,357 | 10.86% | 160 | 2.9 | 1,248 | 14.69% |
| 9 | Al₁₃Fe₄(containing Nd) | 113 | 2.3 | 1,382 | 10.23% | 155 | 3.8 | 1,720 | 14.50% |
| 10 | Al₁₃Fe₄(containing Nd) | 69 | 2.1 | 3,190 | 9.64% | 94 | 3.1 | 3,673 | 13.96% |
| 11 | Al₁₃Fe₄(containing Nd) | 65 | 1.9 | 3,463 | 10.27% | 90 | 2.8 | 3,526 | 13.60% |
| 12 | Al₁₃Fe₄(containing Nd) | 77 | 1.9 | 2,343 | 9.75% | 96 | 2.7 | 2,166 | 9.86% |
| 13 | Al₁₃Fe₄ | 130 | 2.4 | 1,406 | 13.20% | 170 | 3.1 | 1,368 | 17.00% |
| 14 | Al₁₃Fe₄ | 130 | 2.6 | 1,478 | 12.81% | 180 | 3.1 | 1,418 | 19.76% |
| 15 | Al₁₃Fe₄(containing Nd) | 122 | 2.6 | 1,489 | 11.36% | 168 | 3.0 | 1,442 | 18.09% |
| 16 | Al₁₃Fe₄(containing Nd) | 78 | 2.2 | 3,159 | 11.65% | 105 | 2.4 | 3,110 | 19.05% |
| 17 | Al₁₃Fe₄(containing Nd) | 71 | 2.0 | 3,738 | 12.56% | 98 | 2.3 | 3,491 | 19.44% |
| 18 | Al₁₃Fe₄(containing Nd) | 82 | 1.9 | 2,553 | 12.05% | 151 | 2.8 | 1,722 | 18.70% |
| 19 | Al₁₃Fe₄ | 200 | 2.7 | 733 | 14.48% | 320 | 5.8 | 733 | 17.25% |
| 20 | Al₁₃Fe₄ | 130 | 2.2 | 141 | 1.44% | 590 | 7.1 | 62 | 4.05% |
| 21 | Al₁₃Fe₄ | 150 | 2.3 | 401 | 5.23% | 630 | 8.0 | 168 | 11.11% |
| 22 | Al₁₃Fe₄ | 160 | 2.3 | 475 | 7.05% | 760 | 9.5 | 253 | 20.51% |
| 23 | Al₁₃Fe₄ | 160 | 2.5 | 541 | 7.39% | 790 | 9.5 | 280 | 24.53% |
| 24 | Al₁₃Fe₄ | 170 | 2.7 | 689 | 9.83% | 890 | 8.5 | 285 | 35.41% |
| 25 | Al₁₃Fe₄ | 170 | 3.1 | 792 | 9.84% | 950 | 8.5 | 308 | 43.60% |
| 26 | Al₁₃Fe₄ | 170 | 3.2 | 831 | 10.01% | 980 | 9.0 | 318 | 45.25% |

TABLE 3

| | | | | | Solid | Solid | | | | |
|---|---|---|---|---|---|---|---|---|---|---|
| | | | | | solution | solution | | | 0.2% | |
| | | Type of | | | content of | content of | Electrical | Tensile | proof | Elongation |
| Sample | Casting | first | Content | Content | Al phase | Al phase | conductivity | strength | stress | at break |
| No. | method | element | (mass %) | (at %) | (mass %) | (at %) | (IACS %) | (MPa) | (%) | (%) |
| 31 | Liquid | Cr | 2 | 1.05 | 0.82 | 0.43 | 58 | 155 | 68 | 15 |
| | quenching | | | | | | | | | |
| | method | | | | | | | | | |
| 32 | Liquid | Cr | 3 | 1.58 | 0.84 | 0.44 | 57 | 253 | 73 | 13 |
| | quenching | | | | | | | | | |
| | method | | | | | | | | | |
| 33 | Liquid | Cr | 6 | 3.21 | 0.88 | 0.46 | 55 | 320 | 92 | 10 |
| | quenching | | | | | | | | | |
| | method | | | | | | | | | |
| 34 | Liquid | Cr | 8 | 4.32 | 1.1 | 0.57 | 47 | 350 | 143 | 3 |
| | quenching | | | | | | | | | |
| | method | | | | | | | | | |
| 35 | Mold | Cr | 2 | 1.05 | 0.63 | 0.33 | 57 | 128 | 72 | 13 |
| | casting | | | | | | | | | |
| | method | | | | | | | | | |
| 36 | Mold | Cr | 3 | 1.58 | 0.65 | 0.34 | 55 | 142 | 84 | 9 |
| | casting | | | | | | | | | |
| | method | | | | | | | | | |
| 37 | Mold | Cr | 6 | 3.21 | 0.77 | 0.40 | 51 | 181 | 96 | 7 |
| | casting | | | | | | | | | |
| | method | | | | | | | | | |
| 38 | Mold | Cr | 8 | 4.32 | 0.93 | 0.48 | 48 | 236 | 102 | 2 |
| | casting | | | | | | | | | |
| | method | | | | | | | | | |

TABLE 4

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 31 | Al₄₅Cr₇ | 60 | 2.0 | 188 | 0.45% | 143 | 3.6 | 226 | 1.71% |
| 32 | Al₄₅Cr₇ | 80 | 2.2 | 1,020 | 3.96% | 153 | 3.7 | 964 | 8.13% |
| 33 | Al₄₅Cr₇ | 160 | 2.8 | 1,200 | 14.63% | 218 | 3.6 | 1,030 | 18.13% |
| 34 | Al₄₅Cr₇ | 220 | 3.2 | 680 | 13.71% | 424 | 6.3 | 675 | 25.63% |
| 35 | Al₄₅Cr₇ | 96 | 2.2 | 203 | 1.13% | 950 | 9.2 | 37 | 4.89% |
| 36 | Al₄₅Cr₇ | 130 | 2.3 | 264 | 2.59% | 833 | 10.5 | 202 | 17.78% |
| 37 | Al₄₅Cr₇ | 140 | 2.3 | 416 | 4.73% | 917 | 11.3 | 315 | 31.23% |
| 38 | Al₄₅Cr₇ | 168 | 2.5 | 670 | 10.09% | 920 | 12.0 | 420 | 39.50% |

TABLE 5

| | | | | | Solid | Solid | | | | |
|---|---|---|---|---|---|---|---|---|---|---|
| | | | | | solution | solution | | | 0.2% | |
| | | Type of | | | content of | content of | Electrical | Tensile | proof | Elongation |
| Sample | Casting | first | Content | Content | Al phase | Al phase | conductivity | strength | stress | at break |
| No. | method | element | (mass %) | (at %) | (mass %) | (at %) | (IACS %) | (MPa) | (%) | (%) |
| 41 | Liquid | Ni | 3 | 1.40 | 0.95 | 0.44 | 57 | 183 | 74 | 14 |
| | quenching | | | | | | | | | |
| | method | | | | | | | | | |
| 42 | Liquid | Ni | 3.5 | 1.64 | 1.0 | 0.46 | 56 | 292 | 80 | 13 |
| | quenching | | | | | | | | | |
| | method | | | | | | | | | |
| 43 | Liquid | Ni | 5 | 2.36 | 1.1 | 0.51 | 55 | 340 | 98 | 10 |
| | quenching | | | | | | | | | |
| | method | | | | | | | | | |
| 44 | Liquid | Ni | 7 | 3.34 | 1.2 | 0.56 | 46 | 370 | 152 | 2 |
| | quenching | | | | | | | | | |
| | method | | | | | | | | | |
| 45 | Mold | Ni | 2 | 0.93 | 0.88 | 0.41 | 58 | 155 | 84 | 12 |
| | casting | | | | | | | | | |
| | method | | | | | | | | | |
| 46 | Mold | Ni | 3.5 | 1.64 | 0.93 | 0.43 | 57 | 168 | 91 | 7 |
| | casting | | | | | | | | | |
| | method | | | | | | | | | |
| 47 | Mold | Ni | 5 | 2.36 | 1.0 | 0.46 | 53 | 195 | 112 | 4 |
| | casting | | | | | | | | | |
| | method | | | | | | | | | |
| 48 | Mold | Ni | 7 | 3.34 | 1.0 | 0.46 | 50 | 245 | 120 | 1 |
| | casting | | | | | | | | | |
| | method | | | | | | | | | |

TABLE 6

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 41 | Al₃Ni | 43 | 1.8 | 295 | 0.40% | 93 | 2.9 | 226 | 0.90% |
| 42 | Al₃Ni | 53 | 2.1 | 1,530 | 2.73% | 132 | 3.5 | 994 | 6.60% |
| 43 | Al₃Ni | 78 | 2.5 | 2,300 | 7.46% | 203 | 3.9 | 1,350 | 19.08% |
| 44 | Al₃Ni | 120 | 2.8 | 1,030 | 7.06% | 306 | 4.8 | 865 | 22.48% |
| 45 | Al₃Ni | 74 | 2.0 | 300 | 1.11% | 630 | 7.2 | 37 | 2.75% |
| 46 | Al₃Ni | 88 | 2.1 | 399 | 1.98% | 583 | 7.6 | 202 | 12.04% |
| 47 | Al₃Ni | 133 | 2.2 | 720 | 7.72% | 708 | 9.3 | 315 | 22.66% |
| 48 | Al₃Ni | 171 | 2.2 | 1,020 | 18.03% | 760 | 10.1 | 420 | 32.03% |

TABLE 7

| | | | | | Solid | Solid | | | | |
|---|---|---|---|---|---|---|---|---|---|---|
| | | | | | solution | solution | | | 0.2% | |
| | | Type of | | | content of | content of | Electrical | Tensile | proof | Elongation |
| Sample | Casting | first | Content | Content | Al phase | Al phase | conductivity | strength | stress | at break |
| No. | method | element | (mass %) | (at %) | (mass %) | (at %) | (IACS %) | (MPa) | (%) | (%) |
| 51 | Liquid | Co | 3 | 1.40 | 0.40 | 0.18 | 60 | 164 | 63 | 21 |
| | quenching | | | | | | | | | |
| | method | | | | | | | | | |
| 52 | Liquid | Co | 3.5 | 1.63 | 0.53 | 0.24 | 58 | 250 | 66 | 17 |
| | quenching | | | | | | | | | |
| | method | | | | | | | | | |
| 53 | Liquid | Co | 4 | 1.87 | 0.56 | 0.26 | 52 | 320 | 82 | 10 |
| | quenching | | | | | | | | | |
| | method | | | | | | | | | |
| 54 | Liquid | Co | 6 | 2.84 | 0.71 | 0.33 | 48 | 340 | 99 | 5 |
| | quenching | | | | | | | | | |
| | method | | | | | | | | | |
| 55 | Mold | Co | 3 | 1.40 | 0.36 | 0.17 | 59 | 116 | 48 | 17 |
| | casting | | | | | | | | | |
| | method | | | | | | | | | |
| 56 | Mold | Co | 3.5 | 1.63 | 0.38 | 0.17 | 58 | 129 | 49 | 12 |
| | casting | | | | | | | | | |
| | method | | | | | | | | | |
| 57 | Mold | Co | 4 | 1.87 | 0.46 | 0.21 | 55 | 141 | 74 | 8 |
| | casting | | | | | | | | | |
| | method | | | | | | | | | |
| 58 | Mold | Co | 6 | 2.84 | 0.53 | 0.24 | 52 | 183 | 78 | 3 |
| | casting | | | | | | | | | |
| | method | | | | | | | | | |

TABLE 8

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 51 | Al₉Co₂ | 76 | 2.1 | 139 | 0.51% | 131 | 3.4 | 266 | 1.79% |
| 52 | Al₉Co₂ | 83 | 2.4 | 961 | 3.68% | 127 | 3.4 | 1,022 | 6.43% |
| 53 | Al₉Co₂ | 110 | 2.8 | 1,110 | 6.40% | 188 | 3.3 | 1,360 | 19.42% |
| 54 | Al₉Co₂ | 163 | 3.3 | 550 | 5.90% | 359 | 5.5 | 864 | 26.97% |
| 55 | Al₉Co₂ | 125 | 2.3 | 98 | 0.88% | 660 | 8.5 | 53 | 3.61% |
| 56 | Al₉Co₂ | 150 | 2.5 | 183 | 2.18% | 608 | 9.0 | 224 | 12.28% |
| 57 | Al₉Co₂ | 193 | 2.8 | 328 | 5.83% | 942 | 10.8 | 301 | 32.95% |
| 58 | Al₉Co₂ | 216 | 3.5 | 830 | 14.70% | 1,000 | 12.0 | 343 | 38.11% |

TABLE 9

| | | | | | Solid | Solid | | | | |
|---|---|---|---|---|---|---|---|---|---|---|
| | | | | | solution | solution | | | 0.2% | |
| | | Type of | | | content of | content of | Electrical | Tensile | proof | Elongation |
| Sample | Casting | first | Content | Content | Al phase | Al phase | conductivity | strength | stress | at break |
| No. | method | element | (mass %) | (at %) | (mass %) | (at %) | (IACS %) | (MPa) | (%) | (%) |
| 61 | Liquid | Ti | 2 | 1.14 | 0.70 | 0.40 | 57 | 184 | 75 | 15 |
| | quenching | | | | | | | | | |
| | method | | | | | | | | | |
| 62 | Liquid | Ti | 3 | 1.71 | 0.73 | 0.41 | 55 | 273 | 83 | 13 |
| | quenching | | | | | | | | | |
| | method | | | | | | | | | |
| 63 | Liquid | Ti | 7 | 4.07 | 0.75 | 0.42 | 50 | 361 | 94 | 10 |
| | quenching | | | | | | | | | |
| | method | | | | | | | | | |
| 64 | Liquid | Ti | 9 | 5.28 | 0.86 | 0.49 | 45 | 370 | 115 | 2 |
| | quenching | | | | | | | | | |
| | method | | | | | | | | | |
| 65 | Mold | Ti | 2 | 1.14 | 0.58 | 0.33 | 58 | 160 | 63 | 12 |
| | casting | | | | | | | | | |
| | method | | | | | | | | | |
| 66 | Mold | Ti | 3 | 1.71 | 0.62 | 0.35 | 56 | 177 | 69 | 8 |
| | casting | | | | | | | | | |
| | method | | | | | | | | | |
| 67 | Mold | Ti | 7 | 4.07 | 0.65 | 0.37 | 49 | 224 | 83 | 4 |
| | casting | | | | | | | | | |
| | method | | | | | | | | | |
| 68 | Mold | Ti | 8 | 4.67 | 0.69 | 0.39 | 47 | 248 | 90 | 1 |
| | casting | | | | | | | | | |
| | method | | | | | | | | | |

TABLE 10

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 61 | Al₃Ti | 47 | 1.9 | 364 | 0.56% | 78 | 2.9 | 215 | 0.60% |
| 62 | Al₃Ti | 60 | 2.0 | 2,110 | 5.06% | 115 | 2.8 | 970 | 6.11% |
| 63 | Al₃Ti | 86 | 2.4 | 2,840 | 11.67% | 174 | 2.6 | 1,230 | 19.10% |
| 64 | Al₃Ti | 135 | 2.7 | 1,230 | 11.07% | 330 | 3.8 | 670 | 25.60% |
| 65 | Al₃Ti | 84 | 1.8 | 328 | 1.71% | 480 | 8.3 | 48 | 1.79% |
| 66 | Al₃Ti | 103 | 1.9 | 495 | 3.66% | 408 | 9.4 | 148 | 3.51% |
| 67 | Al₃Ti | 140 | 2.3 | 924 | 10.50% | 558 | 11.6 | 245 | 8.78% |
| 68 | Al₃Ti | 183 | 2.7 | 1,230 | 20.43% | 576 | 12.8 | 270 | 9.31% |

TABLE 11

| | | | | | Solid | Solid | | | | |
|---|---|---|---|---|---|---|---|---|---|---|
| | | | | | solution | solution | | | 0.2% | |
| | | Type of | | | content of | content of | Electrical | Tensile | proof | Elongation |
| Sample | Casting | first | Content | Content | Al phase | Al phase | conductivity | strength | stress | at break |
| No. | method | element | (mass %) | (at %) | (mass %) | (at %) | (IACS %) | (MPa) | (%) | (%) |
| 71 | Liquid | Sc | 1.5 | 0.91 | 0.12 | 0.07 | 58 | 220 | 83 | 14 |
| | quenching | | | | | | | | | |
| | method | | | | | | | | | |
| 72 | Liquid | Sc | 2.5 | 1.52 | 0.15 | 0.09 | 57 | 310 | 91 | 12 |
| | quenching | | | | | | | | | |
| | method | | | | | | | | | |
| 73 | Liquid | Sc | 5 | 3.06 | 0.18 | 0.11 | 53 | 395 | 98 | 10 |
| | quenching | | | | | | | | | |
| | method | | | | | | | | | |
| 74 | Liquid | Sc | 7 | 4.32 | 0.24 | 0.14 | 49 | 410 | 135 | 3 |
| | quenching | | | | | | | | | |
| | method | | | | | | | | | |
| 75 | Mold | Sc | 1.5 | 0.91 | 0.11 | 0.07 | 59 | 160 | 72 | 10 |
| | casting | | | | | | | | | |
| | method | | | | | | | | | |
| 76 | Mold | Sc | 2.5 | 1.52 | 0.13 | 0.08 | 58 | 177 | 76 | 7 |
| | casting | | | | | | | | | |
| | method | | | | | | | | | |
| 77 | Mold | Sc | 5 | 3.06 | 0.14 | 0.08 | 52 | 224 | 93 | 2 |
| | casting | | | | | | | | | |
| | method | | | | | | | | | |
| 78 | Mold | Sc | 7 | 4.32 | 0.16 | 0.10 | 49 | 248 | 97 | 1 |
| | casting | | | | | | | | | |
| | method | | | | | | | | | |

TABLE 12

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 71 | Al₃Sc | 33 | 1.8 | 416 | 0.34% | 66 | 2.8 | 249 | 0.52% |
| 72 | Al₃Sc | 48 | 1.9 | 2,540 | 4.11% | 104 | 2.7 | 1,020 | 5.45% |
| 73 | Al₃Sc | 61 | 2.3 | 3,550 | 7.66% | 150 | 2.5 | 1,410 | 16.92% |
| 74 | Al₃Sc | 89 | 2.5 | 1,710 | 7.22% | 380 | 3.2 | 510 | 30.69% |
| 75 | Al₃Sc | 48 | 1.8 | 278 | 0.47% | 330 | 7.6 | 62 | 1.18% |
| 76 | Al₃Sc | 60 | 1.8 | 414 | 1.10% | 300 | 9.0 | 196 | 2.61% |
| 77 | Al₃Sc | 91 | 2.1 | 1,032 | 5.43% | 433 | 11.1 | 291 | 6.55% |
| 78 | Al₃Sc | 123 | 2.4 | 1,440 | 12.14% | 448 | 12.0 | 361 | 8.04% |

TABLE 13

| | | | | | Solid | Solid | | | | |
|---|---|---|---|---|---|---|---|---|---|---|
| | | | | | solution | solution | | | 0.2% | |
| | | Type of | | | content of | content of | Electrical | Tensile | proof | Elongation |
| Sample | Casting | first | Content | Content | Al phase | Al phase | conductivity | strength | stress | at break |
| No. | method | element | (mass %) | (at %) | (mass %) | (at %) | (IACS %) | (MPa) | (%) | (%) |
| 81 | Liquid | Zr | 3 | 0.91 | 0.17 | 0.05 | 55 | 205 | 73 | 15 |
| | quenching | | | | | | | | | |
| | method | | | | | | | | | |
| 82 | Liquid | Zr | 5 | 1.53 | 0.18 | 0.05 | 52 | 277 | 79 | 13 |
| | quenching | | | | | | | | | |
| | method | | | | | | | | | |
| 83 | Liquid | Zr | 6 | 1.85 | 0.19 | 0.06 | 50 | 361 | 85 | 10 |
| | quenching | | | | | | | | | |
| | method | | | | | | | | | |
| 84 | Liquid | Zr | 8 | 2.51 | 0.21 | 0.06 | 44 | 380 | 103 | 4 |
| | quenching | | | | | | | | | |
| | method | | | | | | | | | |
| 85 | Mold | Zr | 3 | 0.91 | 0.16 | 0.05 | 56 | 148 | 68 | 12 |
| | casting | | | | | | | | | |
| | method | | | | | | | | | |
| 86 | Mold | Zr | 5 | 1.53 | 0.18 | 0.05 | 53 | 162 | 71 | 8 |
| | casting | | | | | | | | | |
| | method | | | | | | | | | |
| 87 | Mold | Zr | 6 | 1.85 | 0.19 | 0.06 | 48 | 209 | 82 | 3 |
| | casting | | | | | | | | | |
| | method | | | | | | | | | |
| 88 | Mold | Zr | 8 | 2.51 | 0.19 | 0.06 | 45 | 228 | 84 | 2 |
| | casting | | | | | | | | | |
| | method | | | | | | | | | |

TABLE 14

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 81 | Al₃Zr | 32 | 1.9 | 436 | 0.31% | 58 | 2.6 | 263 | 0.45% |
| 82 | Al₃Zr | 44 | 1.9 | 2,660 | 3.61% | 117 | 2.5 | 985 | 7.19% |
| 83 | Al₃Zr | 58 | 2.2 | 3,720 | 7.58% | 153 | 2.3 | 1,450 | 19.68% |
| 84 | Al₃Zr | 86 | 2.3 | 1,800 | 7.72% | 360 | 2.8 | 453 | 27.96% |
| 85 | Al₃Zr | 47 | 1.8 | 300 | 0.49% | 320 | 7.0 | 73 | 1.42% |
| 86 | Al₃Zr | 60 | 1.9 | 429 | 1.08% | 283 | 8.1 | 213 | 2.81% |
| 87 | Al₃Zr | 90 | 2.1 | 1,080 | 5.51% | 392 | 9.7 | 333 | 7.01% |
| 88 | Al₃Zr | 109 | 2.3 | 1,475 | 10.20% | 408 | 10.4 | 427 | 9.11% |

TABLE 15

| | | | | | Solid | Solid | | | | |
|---|---|---|---|---|---|---|---|---|---|---|
| | | | | | solution | solution | | | 0.2% | |
| | | Type of | | | content of | content of | Electrical | Tensile | proof | Elongation |
| Sample | Casting | first | Content | Content | Al phase | Al phase | conductivity | strength | stress | at break |
| No. | method | element | (mass %) | (at %) | (mass %) | (at %) | (IACS %) | (MPa) | (%) | (%) |
| 91 | Liquid | Nb | 3 | 0.89 | 0.48 | 0.14 | 56 | 190 | 61 | 17 |
| | quenching | | | | | | | | | |
| | method | | | | | | | | | |
| 92 | Liquid | Nb | 5 | 1.51 | 0.50 | 0.15 | 53 | 267 | 70 | 15 |
| | quenching | | | | | | | | | |
| | method | | | | | | | | | |
| 93 | Liquid | Nb | 10 | 3.13 | 0.51 | 0.15 | 50 | 330 | 77 | 10 |
| | quenching | | | | | | | | | |
| | method | | | | | | | | | |
| 94 | Liquid | Nb | 12 | 3.81 | 0.55 | 0.16 | 46 | 347 | 89 | 5 |
| | quenching | | | | | | | | | |
| | method | | | | | | | | | |
| 95 | Mold | Nb | 3 | 0.89 | 0.24 | 0.07 | 58 | 138 | 54 | 14 |
| | casting | | | | | | | | | |
| | method | | | | | | | | | |
| 96 | Mold | Nb | 5 | 1.51 | 0.25 | 0.07 | 56 | 157 | 58 | 10 |
| | casting | | | | | | | | | |
| | method | | | | | | | | | |
| 97 | Mold | Nb | 10 | 3.13 | 0.28 | 0.08 | 51 | 200 | 69 | 6 |
| | casting | | | | | | | | | |
| | method | | | | | | | | | |
| 98 | Mold | Nb | 12 | 3.81 | 0.31 | 0.09 | 48 | 217 | 73 | 2 |
| | casting | | | | | | | | | |
| | method | | | | | | | | | |

TABLE 16

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 91 | Al₃Nb | 36 | 2.0 | 477 | 0.41% | 59 | 2.9 | 229 | 0.37% |
| 92 | Al₃Nb | 47 | 2.1 | 3,380 | 4.74% | 120 | 2.6 | 1,060 | 7.83% |
| 93 | Al₃Nb | 66 | 2.3 | 4,080 | 10.30% | 158 | 2.4 | 1,378 | 19.11% |
| 94 | Al₃Nb | 90 | 2.6 | 2,280 | 9.47% | 280 | 4.2 | 855 | 21.28% |
| 95 | Al₃Nb | 46 | 1.9 | 400 | 0.58% | 390 | 9.3 | 62 | 1.34% |
| 96 | Al₃Nb | 62 | 2.1 | 519 | 1.28% | 367 | 10.8 | 106 | 1.77% |
| 97 | Al₃Nb | 88 | 2.4 | 1,112 | 4.81% | 500 | 12.3 | 238 | 6.45% |
| 98 | Al₃Nb | 113 | 2.8 | 1,595 | 9.77% | 512 | 14.7 | 263 | 6.24% |

TABLE 17

| | | | | | Solid | Solid | | | | |
|---|---|---|---|---|---|---|---|---|---|---|
| | | | | | solution | solution | | | 0.2% | |
| | | Type of | | | content of | content of | Electrical | Tensile | proof | Elongation |
| Sample | Casting | first | Content | Content | Al phase | Al phase | conductivity | strength | stress | at break |
| No. | method | element | (mass %) | (at %) | (mass %) | (at %) | (IACS %) | (MPa) | (%) | (%) |
| 101 | Liquid | Hf | 8 | 1.30 | 0.32 | 0.05 | 58 | 216 | 82 | 16 |
| | quenching | | | | | | | | | |
| | method | | | | | | | | | |
| 102 | Liquid | Hf | 10 | 1.65 | 0.34 | 0.05 | 56 | 286 | 88 | 14 |
| | quenching | | | | | | | | | |
| | method | | | | | | | | | |
| 103 | Liquid | Hf | 24 | 4.56 | 0.37 | 0.06 | 52 | 366 | 94 | 10 |
| | quenching | | | | | | | | | |
| | method | | | | | | | | | |
| 104 | Liquid | Hf | 26 | 5.04 | 0.41 | 0.06 | 49 | 385 | 114 | 2 |
| | quenching | | | | | | | | | |
| | method | | | | | | | | | |
| 105 | Mold | Hf | 8 | 1.30 | 0.17 | 0.03 | 58 | 152 | 71 | 11 |
| | casting | | | | | | | | | |
| | method | | | | | | | | | |
| 106 | Mold | Hf | 10 | 1.65 | 0.18 | 0.03 | 56 | 168 | 78 | 7 |
| | casting | | | | | | | | | |
| | method | | | | | | | | | |
| 107 | Mold | Hf | 24 | 4.56 | 0.22 | 0.03 | 51 | 225 | 86 | 2 |
| | casting | | | | | | | | | |
| | method | | | | | | | | | |
| 108 | Mold | Hf | 26 | 5.04 | 0.24 | 0.04 | 48 | 247 | 93 | 1 |
| | casting | | | | | | | | | |
| | method | | | | | | | | | |

TABLE 18

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 101 | Al₃Hf | 30 | 1.9 | 526 | 0.33% | 55 | 2.5 | 275 | 0.44% |
| 102 | Al₃Hf | 41 | 2.0 | 3,600 | 4.03% | 94 | 2.4 | 1,130 | 5.55% |
| 103 | Al₃Hf | 58 | 2.1 | 4,450 | 9.50% | 142 | 2.2 | 1,480 | 18.09% |
| 104 | Al₃Hf | 78 | 2.4 | 2,690 | 9.09% | 241 | 2.6 | 990 | 29.49% |
| 105 | Al₃Hf | 42 | 1.9 | 470 | 0.58% | 373 | 8.3 | 55 | 1.23% |
| 106 | Al₃Hf | 57 | 2.0 | 651 | 1.42% | 343 | 9.2 | 104 | 1.76% |
| 107 | Al₃Hf | 84 | 2.2 | 1,240 | 5.30% | 458 | 10.3 | 207 | 5.62% |
| 108 | Al₃Hf | 105 | 2.4 | 1,710 | 10.47% | 464 | 11.0 | 221 | 5.75% |

TABLE 19

| | | | | | Solid | Solid | | | | |
|---|---|---|---|---|---|---|---|---|---|---|
| | | | | | solution | solution | | | 0.2% | |
| | | Type of | | | content of | content of | Electrical | Tensile | proof | Elongation |
| Sample | Casting | first | Content | Content | Al phase | Al phase | conductivity | strength | stress | at break |
| No. | method | element | (mass %) | (at %) | (mass %) | (at %) | (IACS %) | (MPa) | (%) | (%) |
| 111 | Liquid | Ta | 8.5 | 1.37 | 0.56 | 0.08 | 56 | 186 | 69 | 17 |
| | quenching | | | | | | | | | |
| | method | | | | | | | | | |
| 112 | Liquid | Ta | 9.5 | 1.54 | 0.67 | 0.10 | 53 | 268 | 73 | 15 |
| | quenching | | | | | | | | | |
| | method | | | | | | | | | |
| 113 | Liquid | Ta | 20 | 3.59 | 0.82 | 0.12 | 50 | 321 | 81 | 10 |
| | quenching | | | | | | | | | |
| | method | | | | | | | | | |
| 114 | Liquid | Ta | 22 | 4.04 | 0.88 | 0.13 | 45 | 340 | 88 | 5 |
| | quenching | | | | | | | | | |
| | method | | | | | | | | | |
| 115 | Mold | Ta | 8.5 | 1.37 | 0.34 | 0.05 | 55 | 132 | 57 | 18 |
| | casting | | | | | | | | | |
| | method | | | | | | | | | |
| 116 | Mold | Ta | 9.5 | 1.54 | 0.36 | 0.05 | 50 | 151 | 58 | 14 |
| | casting | | | | | | | | | |
| | method | | | | | | | | | |
| 117 | Mold | Ta | 20 | 3.59 | 0.41 | 0.06 | 48 | 198 | 73 | 8 |
| | casting | | | | | | | | | |
| | method | | | | | | | | | |
| 118 | Mold | Ta | 22 | 4.04 | 0.51 | 0.08 | 43 | 218 | 81 | 3 |
| | casting | | | | | | | | | |
| | method | | | | | | | | | |

TABLE 20

| | | Compound in transverse section | | | | Compound in longitudinal section | | | |
|---|---|---|---|---|---|---|---|---|---|
| | | Major- | | | | Major- | | | |
| | | axis | | | | axis | | | |
| Sample | Compound | length | Aspect | Number in | Area | length | Aspect | Number in | Area |
| No. | composition | (nm) | ratio | 5 μm × 5 μm | ratio | (nm) | ratio | 5 μm × 5 μm | ratio |
| 111 | Al₃Ta | 40 | 2.1 | 494 | 0.50% | 59 | 2.8 | 229 | 0.38% |
| 112 | Al₃Ta | 48 | 2.3 | 2,550 | 3.41% | 103 | 2.6 | 1,032 | 5.61% |
| 113 | Al₃Ta | 63 | 2.5 | 3,960 | 8.38% | 148 | 2.4 | 1,410 | 17.16% |
| 114 | Al₃Ta | 79 | 2.8 | 2,530 | 7.52% | 235 | 2.6 | 783 | 22.17% |
| 115 | Al₃Ta | 47 | 2.0 | 450 | 0.66% | 409 | 9.6 | 48 | 1.12% |
| 116 | Al₃Ta | 68 | 2.2 | 603 | 1.67% | 353 | 10.0 | 95 | 1.58% |
| 117 | Al₃Ta | 97 | 2.5 | 1,148 | 5.71% | 500 | 13.4 | 144 | 3.57% |
| 118 | Al₃Ta | 115 | 2.7 | 1,540 | 10.02% | 544 | 15.2 | 154 | 4.00% |

Unless otherwise specified, samples containing the same first element are compared.

### (Composition and Strength and Electrical Conductivity)

As shown in the tables with odd numbers among Tables 1 to 20, in the quenching method sample group, a comparison is made between the samples with the lowest first element content (No. 1, No. 31, etc.), the samples with the highest first element content (No. 19, No. 34, etc.), and the other sample group (No. 32 to No. 33, No. 42 to No. 43, etc.). For the samples containing Fe, the sample group free of Nd (No. 2, No. 7, No. 8, No. 13, and No. 14) is compared. The Al alloy wires of the above sample group have higher tensile strength than the samples with the lowest first element content and have high strength. The Al alloy wires of the above sample group have higher electrical conductivity than the samples with the highest first element content and are electrically conductive.

In the casting method sample group, a comparison is made between the samples with the lowest first element content (No. 20, No. 35, etc.), the samples with the highest first element content (No. 26, No. 38, etc.), and the other sample group (No. 21 to No. 25, No. 36 to No. 37, etc.). The Al alloy wires of the above sample group has high strength with higher tensile strength than the samples with the lowest first element content and has high electrical conductivity with a higher electrical conductivity than the samples with the highest first element content.

One possible reason for the high strength of the Al alloy wires of the above sample group is the higher first element content than the samples with the lowest first element content. For example, the Al alloy wires of the sample group containing Fe contain more than 2% by mass, herein 3% or more by mass, Fe. This is also probably because the Al alloy wires of the above sample group contain a compound of Al and the first element and optional elements, as shown in the SEM observation. A slightly high first element content tends to result in the strength improving effect due to dispersion strengthening of the compound.

One possible reason for the high electrical conductivity of the Al alloy wires of the above sample group is the lower first element content than the samples with the highest first element content. For example, the Al alloy wires of the sample group containing Fe contain less than 12% by mass, herein 10% or less by mass (5.1 atomic percent or less), Fe. This is also probably because the Al alloy wires of the above sample group contain a compound of the first element and optional elements, as described above. The presence of the compound with a moderate first element content can decrease the amount of the first element dissolved in the parent phase and improve the purity of Al in the parent phase. This is also probably because a moderate amount of the compound is less likely to block the electrically conductive path in the parent phase. Thus, the Al alloy wires have high electrical conductivity.

### (Structure and Strength and Electrical Conductivity)

Attention is focused on the Al alloy wires of the quenching method sample group and the Al alloy wires of the casting method sample group in the sample group excluding the samples with the lowest first element content and with the highest first element content (No. 32 to No. 33, No. 36 to No. 37, etc., hereinafter referred to as a particular sample group). For the samples containing Fe, the particular sample group is the sample group free of Nd (No. 2, No. 7, No. 8, No. 13, No. 14, and No. 21 to No. 25). In the particular sample group, samples containing the first element of the same type and having the same first element content are compared.

Even with the same composition, the Al alloy wires of the particular quenching method sample group and the Al alloy wires of the particular casting method sample group are different in tensile strength and electrical conductivity. The Al alloy wires of the particular quenching method sample group have higher tensile strength than the particular casting method sample group. In the particular quenching method sample group, some samples are higher in both tensile strength and electrical conductivity than the particular casting method sample group. Quantitatively, the Al alloy wires of the particular quenching method sample group have a tensile strength of 250 MPa or more and an electrical conductivity of 50% IACS or more and keep the balance of high strength and high electrical conductivity. One possible reason for this is that the particular quenching method sample group and the particular casting method sample group are different in the state of existence of the compound containing Al and the first element, as shown in the tables with even numbers among Tables 1 to 20.

### <Size and Shape of Compound>

As shown in the column of “Compound in longitudinal section” in the tables with even numbers, the major-axis length of the particles composed of the compound is shorter in the Al alloy wires of the particular quenching method sample group than in those of the particular casting method sample group. More specifically, the compound particles in the particular quenching method sample group have a major-axis length of 500 nm or less. The major-axis length herein is 350 nm or less or 220 nm or less. In some samples, the major-axis length is 200 nm or less. The particular quenching method sample group has a major-axis length not more than half, often not more than one-third, the major-axis length of the particular casting method sample group and is very fine.

The aspect ratio of the particles composed of the compound is lower in the Al alloy wires of the particular quenching method sample group than in the Al alloy wires of the particular casting method sample group. More specifically, the compound particles in the particular quenching method sample group have an aspect ratio of 5 or less. The aspect ratio herein is 4 or less and is 3.5 or less, 3.2 or less, or 3.0 or less in some samples. The aspect ratio of the particular quenching method sample group is not more than half, often not more than one-third, of the aspect ratio (7.6 or more) of the particular casting method sample group. Thus, the compound particles in the particular quenching method sample group are closer to spherical than the compound particles in the particular casting method sample group.

The compound particles are fine and close to spherical and therefore tend to be uniformly dispersed. Thus, the Al alloy wires of the particular quenching method sample group can satisfactorily have the following two effects.

(Effect 1) The strength improving effect due to dispersion strengthening of the compound particles.

(Effect 2) The effect of having high electrical conductivity due to a decreased amount of the first element dissolved in the parent phase and due to less blockage of the electrically conductive path in the parent phase caused by the compound particles.

In this test, the compound particles in the Al alloy wires of the particular quenching method sample group satisfy both a major-axis length of 500 nm or less and an aspect ratio of 5 or less. In the Al alloy wire, therefore, the compound particles tend to be more uniformly dispersed, and the strength improving effect and the effect of having high electrical conductivity are more easily produced.

In this test, as shown in the column of “Compound in transverse section” in the tables with even numbers, the compound particles in the transverse section in the Al alloy wires of the particular quenching method sample group satisfy both a major-axis length of 500 nm or less and an aspect ratio of 5 or less. The compound particles in the transverse section have a major-axis length of 160 nm or less or often 150 nm or less and are finer. The compound particles in the transverse section have an aspect ratio of 2.8 or less or often 2.6 or less and are closer to spherical.

The compound particles with a major-axis length of 500 nm or less in both the longitudinal section and the transverse section have small size anisotropy and are fine particles when viewed in any direction. The major-axis length of the compound particles in the longitudinal section is not more than 2.8 times the major-axis length of the compound particles in the transverse section and is not more than 2.5 times, not more than 2.0 times, or not more than 1.5 times in some samples. This also proves small anisotropy.

The compound particles with an aspect ratio of 5 or less in both the longitudinal section and the transverse section have small shape anisotropy and are close to spherical when viewed in any direction. The aspect ratio of the compound particles in the longitudinal section is not more than 1.8 times, often not more than 1.5 times, the aspect ratio of the compound particles in the transverse section. This also proves small anisotropy.

In addition to their small size and shape anisotropy in any direction, the fine and almost spherical compound particles tend to be uniformly dispersed throughout the Al alloy wire. Thus, the Al alloy wires of the particular quenching method sample group can more easily have the strength improving effect and the effect of having high electrical conductivity.

### <Number and Area of Compound>

As shown in the tables with even numbers, the Al alloy wires of the particular quenching method sample group and the particular casting method sample group are different in the number and area ratio of the compound particles per unit area (5 μm×5 μm) in the longitudinal section and in the transverse section.

More specifically, the Al alloy wires of the particular quenching method sample group satisfy the following.

The number in the longitudinal section satisfies 950 or more and 1500 or less, and the area ratio satisfies 5% or more and 20% or less. The number herein is 960 or more and 1480 or less.

The number in the transverse section satisfies 950 or more and 4500 or less, and the area ratio satisfies 2.5% or more and 20% or less. The number herein is 960 or more and 4480 or less.

The number of the compound particles in the Al alloy wires of the particular quenching method sample group is similar in any direction, indicating small anisotropy in the existence of the compound particles. Satisfying the number and area ratio in the above ranges is indicative of a fine compound particle with a small area. This is also proved by a short major-axis length of 500 nm or less.

These show that the Al alloy wires of the particular quenching method sample group contain an adequate amount of the compound containing the first element and contain fine compound particles uniformly dispersed throughout the wire. Thus, the Al alloy wires of the particular quenching method sample group can satisfactorily have the (Effect 1) and (Effect 2).

In contrast, the area ratio in the longitudinal section and the area ratio in the transverse section are particularly different in the Al alloy wires of the particular casting method sample group. This indicates large anisotropy in the existence of the compound particles. In particular, the number in the longitudinal section is small, and the area ratio is high or is comparable to that in the particular quenching method sample group. Thus, one compound particle has a large area and is coarse. This is also supported by the fact that the particular casting method sample group has a longer major-axis length than the particular quenching method sample group. This is also supported by the fact that some Al alloy wires of the particular casting method sample group have a major-axis length of more than 500 nm. One possible reason for the long compound particles in the particular casting method sample group is that at least part of the first element was deposited in the casting, and the cast product containing the deposit containing the first element was used as a wiredrawing material. The deposit was elongated in wire drawing, which results in the long major-axis length.

In this test, in the Al alloy wires of the particular quenching method sample group, the number and area ratio of the compound particles per unit area (5 μm×5 μm) in the longitudinal section and in the transverse section satisfy the above ranges, and the compound particles satisfy both a major-axis length of 500 nm or less and an aspect ratio of 5 or less. The compound particles in the Al alloy wires of the particular quenching method sample group have small size anisotropy, shape anisotropy, and existence anisotropy. Furthermore, the fine and almost spherical compound particles are uniformly dispersed throughout the Al alloy wire. Thus, the high tensile strength and electrical conductivity are more easily achieved. In particular, the first element exists mainly as the compound particles, and the compound particles are fine as described above and are less likely to block the electrically conductive path in the parent phase, though there are a slightly large number of compound particles. The first element content of the parent phase is as low as less than 0.55 atomic percent, which results in the improved purity of Al in the parent phase. These result in higher electrical conductivity.

The first element content of the parent phase in the Al alloy wires of the particular casting method sample group is equal to or higher than that of the particular quenching method sample group. In the Al alloy wires of the particular casting method sample group, however, compound particles with low electrical conductivity are elongated in the axial direction of the wire, exist successively in the axial direction, and are likely to block the electrically conductive path in the parent phase, thus resulting in low electrical conductivity.

### <Comparison by Type of First Element>

Furthermore, in this test, in the Al alloy wires of the particular quenching method sample group, a comparison between the samples containing different first elements shows the following.

(1) For the first elements Fe and Cr, the compound particles containing Al and the first element have almost the same size, shape, number, and area ratio in both the transverse section and the longitudinal section. Thus, the compound particles have smaller anisotropy in size and the others.

(2) The first elements Fe, Cr, Ni, Co, Ti, Sc, and Hf result in higher electrical conductivity. For example, some samples have a high electrical conductivity of 55% IACS or more. Some samples have a high electrical conductivity of 55% IACS or more and a high tensile strength of 280 MPa or more or 300 MPa or more.

(3) The first elements Ti, Sc, Zr, Nb, Hf, and Ta tend to result in finer compound particles containing Al and the first element. This is supported by the fact that almost the same area ratio of the compound particles in the transverse section results in an increase in number, for example, compared with the case of the first element Fe or Cr.

### <Containing Second Element>

Referring to Tables 1 and 2, attention is focused on the samples containing the first element Fe.

Samples with the same Fe content are compared in the samples No. 2, No. 8, and No. 14, which contain Fe but do not contain Nd, and the samples No. 3 to No. 6, No. 9 to No. 12, and No. 15 to No. 18, which contain Fe and Nd. The comparison shows that the sample group containing Nd tends to have higher tensile strength. A comparison is made between the samples with the lowest Nd content (No. 3, No. 9, and No. 15), the samples with the highest Nd content (No. 6, No. 12, and No. 18), and the other sample group (No. 4, No. 5, No. 10, No. 11, No. 16, and No. 17). The comparison shows that the Al alloy wires of the above sample group have higher strength with a tensile strength of 345 MPa or more. In the sample group, the tensile strength increases with the Fe content, and some samples have a tensile strength of 370 MPa or more or 400 MPa or more. The Al alloy wires of the sample group also have high electrical conductivity with an electrical conductivity of 50% IACS or more.

One possible reason for the sample group containing Nd having high electrical conductivity and higher strength is that the compound containing Al, Fe, and Nd is finer. This is also probably due to a larger number of particles composed of the compound. This is also probably due to a smaller amount of Fe dissolved in the parent phase.

More specifically, the compound particles in the Al alloy wires of the sample group have a major-axis length of 105 nm or less, often less than 100 nm, in both the longitudinal section and the transverse section. Thus, the major-axis length is smaller in the samples containing Fe and Nd than in the samples containing Fe but not containing Nd. The compound particles in the Al alloy wires of the sample group have an aspect ratio of less than 3.3 in both the longitudinal section and the transverse section. The compound particles in the Al alloy wires of the sample group are finer and closer to spherical.

In the Al alloy wires of the sample group, the compound particles have a number of 2200 or more and 3800 or less and an area ratio of 4.5% or more and 20% or less in both the longitudinal section and the transverse section. This also proves the fine compound particles in the Al alloy wires of the sample group. Thus, in the Al alloy wires of the sample group, very fine compound particles tend to be more uniformly dispersed in the parent phase.

Furthermore, in the Al alloy wires of the sample group, the amount of Fe dissolved in the parent phase is less than 0.28 atomic percent. Thus, the Al alloy wires of the sample group can more satisfactorily have the (Effect 1) and (Effect 2).

### <Other Mechanical Characteristics>

In the quenching method sample group, a comparison is made between the samples with the lowest first element content, the samples with the highest first element content, and the other sample group (the particular sample group). In the samples containing Nd, a comparison is made between the samples with the lowest Nd content, the samples with the highest Nd content, and the other sample group (the particular sample group). As shown in the tables with odd numbers among Tables 1 to 20, the Al alloy wires of the particular quenching method sample group also have high 0.2% proof stress and elongation at break. More specifically, the 0.2% proof stress is 50 MPa or more or 65 MPa or more. This also proves that the Al alloy wires of the particular quenching method sample group have high strength. In the Al alloy wires of the particular quenching method sample group, many samples have an elongation at break of 10% or more or 12% or more. Even the samples No. 16 and No. 17, which have a higher tensile strength of 400 MPa or more, have a high elongation at break of 7% or more. Thus, even having high strength, the Al alloy wires of the particular quenching method sample group have high toughness and can be easily bent or repeatedly bent. Furthermore, the Al alloy wires of the particular quenching method sample group have a moderate 0.2% proof stress of 100 MPa or less, often 90 MPa or less. Thus, the Al alloy wires can be easily bent or repeatedly bent.

### CONCLUSIONS

Accordingly, it was shown that an Al alloy wire composed of an Al-based alloy with a first element content of more than 1.4 atomic percent and 5.1 atomic percent or less in total keeps the balance of high tensile strength and high electrical conductivity. In particular, it was shown that a high-strength electrically conductive Al alloy wire has a structure in which a first element is dispersed in a parent phase substantially as compound particles, preferably a structure in which fine and almost spherical compound particles are uniformly dispersed.

It was shown that for the first element Fe an Al alloy wire composed of an Al-based alloy containing Fe in the above range and more than 0.006 atomic percent and 0.1 atomic percent or less Nd has higher strength with higher tensile strength. It was also shown that the Al-based alloy wire has a structure in which finer and almost spherical compound particles are dispersed in the parent phase.

It was also shown that such a high-strength electrically conductive Al alloy wire is produced by wire drawing under conditions that the first element and optional elements are not substantially deposited and by heat treatment after the wire drawing to deposit the first element and optional elements. In particular, the following are true in the process of producing a material to be wire-drawn.

(1) A very high cooling rate of a melt to form a thin band or the like results in substantially no deposit of the first element and optional elements.

(2) The thin band or the like can be processed under conditions that the first element and optional elements are not substantially deposited, and the processed product can be satisfactorily wire-drawn.

(3) The heating temperature in heat treatment can be adjusted for the type of first element to sufficiently deposit the first element and optional elements.

The present invention is defined by the appended claims rather than by these embodiments. All modifications that fall within the scope of the claims and the equivalents thereof are intended to be embraced by the claims.

For example, the additive element content, wire diameter, production conditions (the temperature of a melt, the cooling rate in casting, extrusion conditions, heat-treatment conditions, etc.), and the form of a material to be wire-drawn may be appropriately changed in the test example 1. The additive element of the Al-based alloy may include a plurality of first elements.

What is claimed is:

1. An aluminum alloy wire with a composition that contains at least one metallic element selected from the group consisting of Fe, Cr, Ni, Co, Ti, Sc, Zr, Nb, Hf, and Ta in a total amount of more than 1.4 atomic percent and 5.1 atomic percent or less and a remainder of Al and incidental impurities,
wherein the aluminum alloy wire has a tensile strength of 250 MPa or more and
an electrical conductivity of 50% IACS or more.

2. The aluminum alloy wire according to claim 1, wherein the metallic element is Fe.

3. The aluminum alloy wire according to claim 1, wherein the metallic element is Cr, and a Cr content is 1.5 atomic percent or more and 3.3 atomic percent or less.

4. The aluminum alloy wire according to claim 1, wherein the metallic element is Ni, and a Ni content is 1.6 atomic percent or more and 2.4 atomic percent or less.

5. The aluminum alloy wire according to claim 1, wherein the metallic element is Co, and a Co content is 1.6 atomic percent or more and 1.9 atomic percent or less.

6. The aluminum alloy wire according to claim 1, wherein the metallic element is Ti, and a Ti content is 1.7 atomic percent or more and 4.1 atomic percent or less.

7. The aluminum alloy wire according to claim 1, wherein the metallic element is Sc, and a Sc content is 1.5 atomic percent or more and 3.1 atomic percent or less.

8. The aluminum alloy wire according to claim 1, wherein the metallic element is Zr, and a Zr content is 1.5 atomic percent or more and 1.9 atomic percent or less.

9. The aluminum alloy wire according to claim 1, wherein the metallic element is Nb, and a Nb content is 1.5 atomic percent or more and 3.2 atomic percent or less.

10. The aluminum alloy wire according to claim 1, wherein the metallic element is Hf, and a Hf content is 1.6 atomic percent or more and 4.6 atomic percent or less.

11. The aluminum alloy wire according to claim 1, wherein the metallic element is Ta, and a Ta content is 1.5 atomic percent or more and 3.6 atomic percent or less.

12. The aluminum alloy wire according to claim 1, wherein
the aluminum alloy wire has a structure that contains a parent phase and compound particles present in the parent phase, the parent phase being composed mainly of Al, and the compound particles being composed of a compound containing Al and the metallic element, and
the compound particles have a major-axis length of 500 nm or less, or an aspect ratio of 5 or less, or both in a longitudinal section cut in a plane in an axial direction.

13. The aluminum alloy wire according to claim 1, wherein
the aluminum alloy wire has a structure that contains a parent phase and compound particles present in the parent phase, the parent phase being composed mainly of Al, and the compound particles being composed of a compound containing Al and the metallic element,
a 5 μm×5 μm square measurement region is chosen in both a longitudinal section cut in a plane in an axial direction and a transverse section cut in a plane perpendicular to the axial direction,
a number of the compound particles in the measurement region in the longitudinal section is 950 or more and 1500 or less, and a ratio of a total area of the compound particles to an area of the measurement region in the longitudinal section is 5% or more and 20% or less, and
a number of the compound particles in the measurement region in the transverse section is 950 or more and 4500 or less, and a ratio of a total area of the compound particles to an area of the measurement region in the transverse section is 2.5% or more and 20% or less.

14. The aluminum alloy wire according to claim 12, wherein the metallic element content of the parent phase is less than 0.55 atomic percent in total.

15. An aluminum alloy wire with a composition that contains more than 1.4 atomic percent and 5.1 atomic percent or less Fe, more than 0.006 atomic percent and 0.1 atomic percent or less Nd, and a remainder of Al and incidental impurities,
wherein the aluminum alloy wire has a tensile strength of 345 MPa or more and
an electrical conductivity of 50% IACS or more.

16. The aluminum alloy wire according to claim 15, wherein
the aluminum alloy wire has a structure that contains a parent phase and compound particles present in the parent phase, the parent phase being composed mainly of Al, and the compound particles being composed of a compound containing Al, Fe, and Nd, and
the compound particles have a major-axis length of 105 nm or less, or an aspect ratio of less than 3.3, or both in a longitudinal section cut in a plane in an axial direction.

17. The aluminum alloy wire according to claim 15, wherein
the aluminum alloy wire has a structure that contains a parent phase and compound particles present in the parent phase, the parent phase being composed mainly of Al, and the compound particles being composed of a compound containing Al, Fe, and Nd, and
a 5 μm×5 μm square measurement region is chosen in both a longitudinal section cut in a plane in an axial direction and a transverse section cut in a plane perpendicular to the axial direction, and a number of the compound particles in each measurement region is 2200 or more and 3800 or less, and a ratio of a total area of the compound particles to an area of each measurement region is 4.5% or more and 20% or less.

18. The aluminum alloy wire according to claim 16, wherein the parent phase has an Fe content of less than 0.28 atomic percent.

19. The aluminum alloy wire according to claim 1, wherein the aluminum alloy wire has a 0.2% proof stress of 50 MPa or more.

20. The aluminum alloy wire according to claim 1, wherein the aluminum alloy wire has a 0.2% proof stress of 100 MPa or less, or an elongation at break of 10% or more, or both.

21. (canceled)

22. (canceled)

23. (canceled)

24. (canceled)
